(19) United States
(12) Patent Application Publication
(10) Pub. No.: US 2006/0215516 A1
(43) Pub. Date: Sep. 28, 2006

(54) Optical information recording apparatus

(75) Inventor: Yasuhiko Teranishi, Kanagawa-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/363,162

(22) Filed: Feb. 28, 2006

(30) Foreign Application Priority Data
Mar. 22, 2005 (JP) 2005-080877

(51) Int. Cl. G11B 7/12

(52) U.S. Cl. 369/47.53

(57) ABSTRACT

A rewritable optical disc has a laminate of first and second recording layers with first and second trial write areas respectively. Sections of the first trial write area are sequentially used in an order accorded with a direction from an outer disc edge toward an inner disc edge. Sections of the second trial write area are sequentially used in an order accorded with a direction from the inner disc edge toward the outer disc edge. The distance between an innermost used section of the first trial write area and an outermost used section of the second trial write area is calculated. A decision is made as to whether or not the calculated distance is greater than a threshold value. All the used sections in the first and second trial write areas are subjected to signal erasure when the calculated distance is not greater than the threshold value.

### BACKGROUND OF THE INVENTION

1. Field of the Invention

This invention generally relates to an optical information recording apparatus. This invention particularly relates to an apparatus for performing the trial writing and reading of test signals on and from given areas in a rewritable optical information recording medium such as a rewritable optical disc with a plurality of recording layers to decide optimum recording powers of a laser beam applied to the recording medium. In addition, this invention relates to a method of performing the trial writing and reading of test signals on and from given areas in a rewritable optical information recording medium.

2. Description of the Related Art

There are DVDs (digital versatile discs) of various types such as a DVD-R (DVD-recordable), a DVD-RW (DVD-rewritable), and a DVD-RAM. Some DVDs each have a single recording layer while other DVDs each have multiple recording layers.

Regarding a typical single-layer DVD, optimum power control (OPC) is implemented as follows. To record a signal on the DVD, a recording laser beam modulated in accordance with the signal is applied to the DVD. The quality of the recorded signal on the DVD depends on the recording power of the laser beam applied thereto. The recording layer of the DVD has a power calibration area (PCA). Test recording and reproduction (trial write and read) are performed on the DVD before a desired information signal is recorded thereon. During a first stage of the test recording and reproduction, test signals are sequentially recorded on the PCA in the DVD while the recording power of the laser beam is changed among different values. The test signals are assigned to the different recording powers of the laser beam, respectively. During a second stage of the test recording and reproduction, the recorded test signals are reproduced, and the reproduced test signals are evaluated. An optimum recording power of the laser beam is decided on the basis of the results of the evaluation of the reproduced test signals. During the recording of a desired information signal on the DVD which follows the test recording and reproduction, the recording power of the laser beam is controlled at the decided optimum level.

Japanese patent application publication number 10-293926/1998 discloses a DVD-R which has a land track formed with pre-pits representing on-disc address information called LPP (land pre-pit) address information. Before the recording of information data on the DVD-R, the LPP address information is detected therefrom. During the recording of information data, the currently accessed position on the DVD-R is controlled according to the detected LPP address information.

Japanese patent application publication number 2000-311346 discloses an optical disc including first and second recording layers. Each of the recording layers has a data area and a trial write area. The trial write areas in the respective recording layers align with each other. Each of the trial write areas is divided into small portions. The small portions of the trial write area in the first recording layer align with those of the trial write area in the second recording layer, respectively.

Japanese application 2000-311346 also discloses an apparatus for recording and reproducing information on and from the optical disc. In the case where information is required to be recorded on desired one of the recording layers of the optical disc, the apparatus implements trial write and read as follows. One of the small portions of the trial write area in the desired recording layer is selected which is out of alignment with used one or ones of the small portions of the trial write area in the other recording layer. The used one or ones mean one or ones which have already been used for the trial write and read. Test signals are sequentially recorded on the selected small portion of the trial write area in the desired recording layer while the recording power of the laser beam is changed among different values. The recorded test signals are reproduced, and the reproduced test signals are compared. An optimum recording power of the laser beam for the desired recording layer is decided on the basis of the result of the comparison.

Japanese patent application publication number 2004-310997 discloses an optical disc and a drive apparatus therefor. The optical disc includes first and second recording layers each having a data area and a PCA (power calibration area). During the recording of a signal on the second recording layer, a laser beam reaches the second recording layer through the first recording layer. The data area in the first recording layer aligns with that in the second recording layer. The PCA in the first recording layer aligns with that in the second recording layer.

According to Japanese application 2004-310997, the drive apparatus operates as follows. In the case where an information signal has already been recorded on the data area in the first recording layer, the drive apparatus performs the trial writing and reading of test signals on and from the PCA in the first recording layer before implementing the trial writing and reading of test signals on and from the PCA in the second recording layer. Therefore, during the trial write and read utilizing the PCA in the second recording layer, the laser beam reaches the second recording layer through the already-used PCA in the first recording layer. During the later recording of an information signal on the data area in the second recording layer, the laser beam reaches the second recording layer through the already-used data area in the first recording layer. Accordingly, the conditions concerning the laser beam during the recording of an information signal on the data area in the second recording layer are similar to those during the trial write and read utilizing the PCA in the second recording layer. Thus, the optimum power of the laser beam for recording an information signal on the second recording layer which has been decided by the trial write and read utilizing the PCA in the second recording layer is reliable and accurate. On the other hand, in the case where the data area in the first recording layer has not been used yet, the drive apparatus performs the trial writing and reading of test signals on and from the PCA in the second recording layer before implementing the trial writing and reading of test signals on and from the PCA in the first recording layer. Therefore, during the trial write and read utilizing the PCA in the second recording layer, the laser beam reaches the second recording layer through the unused PCA in the first recording layer. During the later recording of an information signal on the data area in the second recording layer, the laser beam reaches the second recording layer through the unused data area in the first recording layer. Accordingly, the conditions concerning the laser beam during the recording of an information signal on the data area in the second recording layer are similar to those during the trial write and read utilizing the PCA in the second recording layer. Thus, the optimum power of the laser beam for recording an information signal on the second recording layer which has been decided by the trial write and read utilizing the PCA in the second recording layer is reliable and accurate.

Japanese patent application publication number 2000-251254 discloses a recording apparatus for an optical disc which implements an OPC (optimum power control) procedure. The optical disc has a trial write area divided into small portions. According to Japanese application 2000-251254, the trial write area deteriorates and the characteristics thereof vary as the trial write and read are repetitively implemented with respect thereto. Thus, in the case where only one of the small portions of the trial write area is more frequently used for the trial write and read, the small portion in question more considerably deteriorates than the other small portions. This condition reduces the reliability and accuracy of an optimum recording power of a laser beam which is decided by the trial write and read.

Japanese application 2000-231254 further discloses that each time the trial write and read are performed, one is selected from the small portions of the trial write area at random, and that the selected small portion is actually used for the present trial write and read. The random selection causes the small portions of the trial write area to equally deteriorate as the trial write and read are repetitively implemented. Therefore, the characteristics of the small portions of the trial write area are kept similar to each other. This condition provides good reliability and accuracy of the optimum recording laser power decided by the trial write and read.

In addition, Japanese application 2000-231254 discloses that information representing the number of times each of the small portions of the trial write area has been used for the trial write and read is stored as a test zone management table. Each time the trial write and read are performed, one is selected from the small portions of the trial write area which corresponds to the smallest of the numbers of times of use. The selected small portion is actually used for the present trial write and read. The above-mentioned procedure prevents only one or some of the small portions of the trial write area from more considerably deteriorating than the other small portions.

Japanese patent application publication number 2004-86992 discloses a recording apparatus for an optical disc which implements trial write and read. The optical disc has an information area and a trial write area. The trial write area is divided into small portions. The apparatus of Japanese application 2004-86992 is designed to prevent only one of the small portions of the trial write area from being more frequently and concentratedly used for the trial write and read than the other small portions. According to Japanese application 2004-86992, the information area is divided into small portions, and a one-to-one correspondence is previously provided between the small portions of the trial write area and those of the information area. A decision is made as to which of the small portions of the information area will be used by forthcoming information recording. By referring to the one-to-one correspondence, one is selected from the small portions of the trial write area which corresponds to the decided small portion of the information area. The trial write and read are performed by using the selected small portion of the trial write area.

Generally, the maximum number of times of signal rewriting with respect to an optical disc depends on the maximum number of times the reliable and accurate trial write and read (the reliable and accurate OPC procedure) can be performed by use of the optical disc. To increase the maximum number of times of OPC, it is desirable to consider the deterioration of the trial write area (or the PCA) in the optical disc.

### SUMMARY OF THE INVENTION

It is a first object of this invention to provide an optical information recording apparatus which allows an increased maximum number of times the reliable and accurate trial write and read (the reliable and accurate OPC procedure) can be performed by use of an optical recording medium, and hence which allows an increased maximum number of times of signal rewriting with respect to the optical recording medium.

It is a second object of this invention to provide an improved optical information recording method.

A first aspect of this invention provides an apparatus for recording information on a rewritable optical disc having a laminate of recording layers including first and second recording layers each with a trial write area. The apparatus comprises first means for sequentially using sections of the trial write area in the first recording layer in an order accorded with a radial direction from an outer disc edge toward an inner disc edge while recording test signals thereon; second means for sequentially using sections of the trial write area in the second recording layer in an order accorded with a radial direction from the inner disc edge toward the outer disc edge while recording test signals thereon; third means for calculating a radial distance between an innermost one of used ones among the sections of the trial write area in the first recording layer and an outermost one of used ones among the sections of the trial write area in the second recording layer; fourth means for deciding whether or not the radial distance calculated by the third means is greater than a preset threshold value; and fifth means for erasing the recorded test signals from the used ones among the sections of the trial areas in the first and second recording layers when the fourth means decides that the radial distance is not greater than the preset threshold value.

A second aspect of this invention provides an apparatus for recording information on a rewritable optical disc having a laminate of recording layers including first and second recording layers each with a trial write area. The apparatus comprises first means for sequentially using sections of the trial write area in the first recording layer in an order accorded with a radial direction from an outer disc edge toward an inner disc edge while recording test signals thereon; second means for sequentially using sections of the trial write area in the second recording layer in an order accorded with a radial direction from the inner disc edge toward the outer disc edge while recording test signals thereon; third means for calculating a radial distance between an innermost one of used ones among the sections of the trial write area in the first recording layer and an outermost one of used ones among the sections of the trial write area in the second recording layer; fourth means for deciding whether or not the radial distance calculated by the third means is greater than a preset threshold value; fifth means for calculating a size of a used zone defined by the used ones among the sections of the trial write area in the first recording layer; sixth means for calculating a size of a used zone defined by the used ones among the sections of the trial write area in the second recording layer; seventh means for deciding which of the sizes calculated by the fifth and sixth means is greater; eighth means for erasing the recorded test signals from the used ones among the sections of the trial area in the first recording layer when the fourth means decides that the radial distance is not greater than the preset threshold value and the seventh means decides that the size calculated by the fifth means is greater; and ninth means for erasing the recorded test signals from the used ones among the sections of the trial area in the second recording layer when the fourth means decides that the radial distance is not greater than the preset threshold value and the seventh means decides that the size calculated by the sixth means is greater.

A third aspect of this invention is based on the first aspect thereof, and provides an apparatus wherein the preset threshold value is chosen in the light of (1) a manufacturing tolerance for the optical disc and (2) a diameter of a laser beam in one of the first and second recording layers which is focused through the one of the first and second recording layers on the other of the first and second recording layers.

A fourth aspect of this invention is based on the second aspect thereof, and provides an apparatus wherein the preset threshold value is chosen in the light of (1) a manufacturing tolerance for the optical disc and (2) a diameter of a laser beam in one of the first and second recording layers which is focused through the one of the first and second recording layers on the other of the first and second recording layers.

A fifth aspect of this invention provides an apparatus for recording information on a rewritable optical disc having a laminate of recording layers including first and second recording layers each with a trial write area. The apparatus comprises first means for using a first zone in the trial write area of the first recording layer for trial write; second means for recording dummy data on a second zone in the trial write area of the first recording layer, the second zone being separate from the first zone; and third means for using the trial write area of the second recording layer for trial write while applying a laser beam to the trial write area of the second recording layer through either the first zone in the trial write area of the first recording layer which has been used by the first means or the second zone in the trial write area of the first recording layer on which the dummy data has been recorded by the second means.

A sixth aspect of this invention is based on the fifth aspect thereof, and provides an apparatus wherein the dummy data has portions related with on-disc address information.

A seventh aspect of this invention is based on the fifth aspect thereof, and provides an apparatus further comprising fourth means for subjecting a part of the second zone to DC erasure and then using the part for trial write before adding the part to the first zone to expand the first zone.

An eighth aspect of this invention is based on the fifth aspect thereof, and provides an apparatus wherein the first means includes means for using the first zone in the trial write area of the first recording layer for trial write and read to decide an optimum recording power of the laser beam, and the second means includes means for recording the dummy data on the second zone in the trial write area of the first recording layer while applying the laser beam having the decided optimum recording power thereto.

A ninth aspect of this invention provides an apparatus for recording information on a rewritable optical disc having a trial write area. The apparatus comprises first means for selecting one from a first power changing pattern in which a recording power of a laser beam is initially equal to a value expected to correspond to an optimum recording power and is then changed from a minimum value to a maximum value on an upward stepwise basis and a second power changing pattern in which the recording power of the laser beam is initially equal to the value expected to correspond to the optimum recording power and is then changed from the maximum value to the minimum value on a downward stepwise basis; and second means for using the trial write area while applying thereto a laser beam having a recording power which varies in accordance with the power changing pattern selected by the first means.

A tenth aspect of this invention is based on the ninth aspect thereof, and provides an apparatus wherein the first means comprises means for alternately selecting the first power changing pattern and the second power changing pattern.

An eleventh aspect of this invention is based on the ninth aspect thereof, and provides an apparatus wherein the first means comprises means for selecting one from the first power changing pattern and the second power changing pattern at random.

A twelfth aspect of this invention provides a method of recording information on a rewritable optical disc having a laminate of recording layers including first and second recording layers each with a trial write area. The method comprises the steps of sequentially using sections of the trial write area in the first recording layer in an order accorded with a radial direction from an outer disc edge toward an inner disc edge while recording test signals thereon; sequentially using sections of the trial write area in the second recording layer in an order accorded with a radial direction from the inner disc edge toward the outer disc edge while recording test signals thereon; calculating a radial distance between an innermost one of used ones among the sections of the trial write area in the first recording layer and an outermost one of used ones among the sections of the trial write area in the second recording layer; deciding whether or not the calculated radial distance is greater than a preset threshold value; and erasing the recorded test signals from the used ones among the sections of the trial areas in the first and second recording layers when it is decided that the calculated radial distance is not greater than the preset threshold value.

A thirteenth aspect of this invention provides a method of recording information on a rewritable optical disc having a laminate of recording layers including first and second recording layers each with a trial write area. The method comprises the steps of sequentially using sections of the trial write area in the first recording layer in an order accorded with a radial direction from an outer disc edge toward an inner disc edge while recording test signals thereon; sequentially using sections of the trial write area in the second recording layer in an order accorded with a radial direction from the inner disc edge toward the outer disc edge while recording test signals thereon; calculating a radial distance between an innermost one of used ones among the sections of the trial write area in the first recording layer and an outermost one of used ones among the sections of the trial write area in the second recording layer; deciding whether or not the calculated radial distance is greater than a preset threshold value; calculating a first size of a used zone defined by the used ones among the sections of the trial write area in the first recording layer; calculating a second size of a used zone defined by the used ones among the sections of the trial write area in the second recording layer; deciding which of the calculated first and second sizes is greater; erasing the recorded test signals from the used ones among the sections of the trial area in the first recording layer when it is decided that the calculated radial distance is not greater than the preset threshold value and that the calculated first size is greater; and erasing the recorded test signals from the used ones among the sections of the trial area in the second recording layer when it is decided that the calculated radial distance is not greater than the preset threshold value and that the calculated second size is greater.

This invention has advantages as follows. It is possible to prevent only one or some of the sections of the trial write areas in the first and second recording layers from being more frequently and concentratedly used for the OPC procedure than the other sections. Thus, it is possible to increase the maximum number of times the reliable and accurate OPC procedure can be performed by using the trial write areas until the trial write areas deteriorate into an unacceptable range. This results in an increased maximum number of times of signal rewriting with respect to the optical disc.

A specified part of the trial write area in the optical disc is prevented from more frequently receiving a high recording laser power so that the whole of the trial write area deteriorates more slowly. Accordingly, it is possible to provide an increased maximum number of times of signal rewriting with respect to the optical disc.

### BRIEF DESCRIPTION OF THE DRAWINGS

FIG. 1 is a diagram of a first prior-art DVD-R or DVD-RW.

FIG. 2 is a diagram of the structure of one prior-art ECC block used for the data recording on a data area in an optical disc.

FIG. 3 is a diagram of the structure of one prior-art sector in the ECC block of FIG. 2.

FIG. 4 is a perspective view of a second prior-art DVD-R or DVD-RW.

FIG. 5 is a diagram of a third prior-art DVD-R.

FIG. 6 is a sectional view of a portion of the prior-art DVD-R in FIG. 5 and a portion of a prior-art optical pickup.

FIG. 7 is a sectional view of PCAs in the prior-art DVD-R of FIG. 5.

FIG. 8 is a block diagram of an information recording and reproducing system including a host apparatus, an optical-disc drive apparatus, and an optical disc according to a first embodiment of this invention.

FIG. 9 is a time-domain diagram of the waveform of a laser beam used for the recording of information on the optical disc in FIG. 8.

FIG. 10 is a sectional diagram of R-information areas of the optical disc in FIG. 8 which is in a state occurring at a given stage.

FIG. 11 is a sectional diagram of the R-information areas of the optical disc in FIG. 8 which is in a state occurring at a stage after that in FIG. 10.

FIG. 12 is a diagram of a pattern in which the recording power of a laser beam is changed among ten different values, and a “β” curve related with an evaluation measure “β”.

FIG. 13 is a time-domain diagram of the waveform of a reproduced RF signal corresponding to a proper recording laser power and having substantially equal upper-side amplitude “a” and lower-side amplitude “b”.

FIG. 14 is a time-domain diagram of the waveform of a reproduced RF signal corresponding to an over recording laser power and having a greater upper-side amplitude “a” and a smaller lower-side amplitude “b”.

FIG. 15 is a time-domain diagram of the waveform of a reproduced RF signal corresponding to an insufficient recording laser power and having a smaller upper-side amplitude “a” and a greater lower-side amplitude “b”.

FIG. 16 is a sectional diagram of the R-information areas of the optical disc in FIG. 8 which is in a state occurring at a stage after that in FIG. 11.

FIG. 17 is a flowchart of a control program for the optical-disc drive apparatus in FIG. 8.

FIG. 18 is a sectional diagram of R-information areas of an optical disc which is in a state occurring at a given stage in a second embodiment of this invention.

FIG. 19 is a sectional diagram of the R-information areas of the optical disc in FIG. 18 which is in a state occurring at a stage after that in FIG. 18.

FIG. 20 is a sectional diagram of the R-information areas of the optical disc in FIG. 18 which is in a state occurring at a stage after that in FIG. 19.

FIG. 21 is a sectional diagram of the R-information areas of the optical disc in FIG. 18 which is in a state occurring at a stage after that in FIG. 20.

FIG. 22 is a flowchart of a control program for an optical-disc drive apparatus in the second embodiment of this invention.

FIG. 23 is a sectional diagram of R-information areas of an optical disc which is in a state occurring at a given stage in a third embodiment of this invention.

FIG. 24 is a sectional diagram of the R-information areas of the optical disc in FIG. 23 which is in a state occurring at a stage after that in FIG. 23.

FIG. 25 is a sectional diagram of the R-information areas of the optical disc in FIG. 23 which is in a state occurring at a stage after that in FIG. 24.

FIG. 26 is a sectional diagram of the R-information areas of the optical disc in FIG. 23 which is in a state occurring at a stage after that in FIG. 25.

FIG. 27 is a sectional diagram of the R-information areas of the optical disc in FIG. 23 which is in a state occurring at a stage after that in FIG. 26.

FIG. 28 is a diagram of a first pattern in which the recording power of a laser beam is changed among ten different values in a fourth embodiment of this invention.

FIG. 29 is a diagram of a second pattern in which the recording power of the laser beam is changed among the ten different values in the fourth embodiment of this invention.

### DETAILED DESCRIPTION OF THE INVENTION

Prior-art optical discs and prior-art apparatuses will be explained below for a better understanding of this invention.

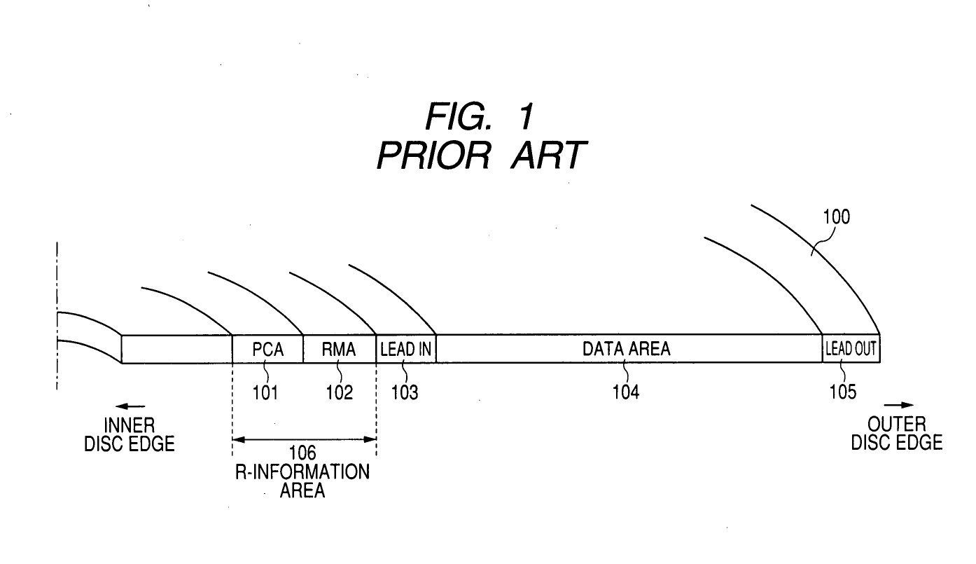

FIG. 1 shows a first prior-art DVD-R or DVD-RW 100. The prior-art disc 100 is of a single-recording-layer type. The prior-art disc 100 has a central opening, and thus has an inner circumferential edge in addition to an outer circumferential edge. As shown in FIG. 1, a recording area of the prior-art disc 100 is divided into a power calibration area (PCA) 101, a recording management area (RMA) 102, a lead-in area 103, a data area 104, and a lead-out area 105 which are successively arranged in that order as viewed in a radial direction from the inner disc edge toward the outer disc edge.

The PCA 101 and the RMA 102 constitute an R-information area 106. The data area 104 is assigned to user data. The lead-in area 103 and the lead-out area 105 are used as buffers for absorbing overruns of a recording and reproducing head (an optical pickup) of a prior-art optical-disc drive apparatus.

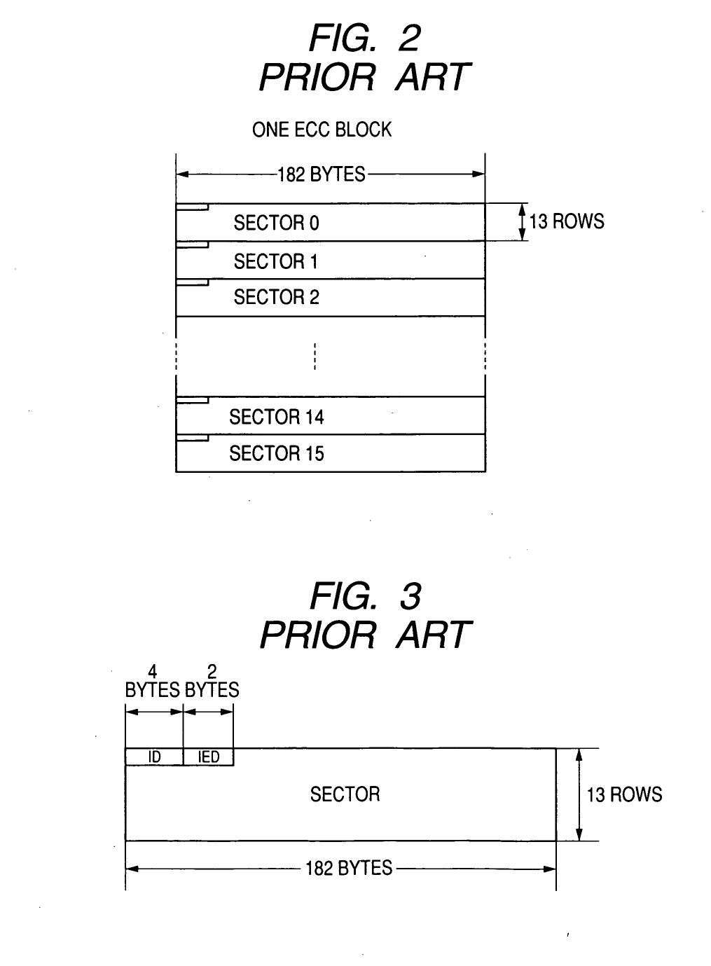

User data is recorded on the data area for every ECC block. As shown in FIG. 2, one ECC block is divided into 16 sectors numbered “0”, “1”, “2”, . . . , “15”. One sector consists of 13 rows each having 182 bytes. One ECC block contains 32-kilobyte user data, error detection and correction parities (error detection and correction code words), and sync signals.

As shown in FIG. 3, one sector has 4-byte ID (identification data) at its head. The 4-byte ID is followed by 2-byte IED (error detection and correction code words) therefor. The 4-byte ID represents a unique sector number, that is, an ID sector number which has a given relation with LPP (land pre-pit) address information.

A prior-art drive apparatus for the prior-art disc 100 in FIG. 1 implements trial write and read before recording desired user data (for example, contents data) on the prior-art disc 100. During a first stage of the trial write and read, test signals are sequentially recorded on the PCA 101 in the prior-art disc 100 while the recording power of a laser beam is changed among different values. The test signals are assigned to the different recording powers of the laser beam, respectively. During a second stage of the trial write and read, the recorded test signals are reproduced, and the reproduced test signals are evaluated. An optimum recording power of the laser beam is decided on the basis of the results of the evaluation of the reproduced test signals. During the recording of desired user data on the prior-art disc 100 which follows the trial write and read, the recording power of the laser beam is controlled at the decided optimum level. Deciding the optimum recording power of the laser beam on the basis of the reproduced test signals is called OPC (optimum power control). The PCA 101 is used for the OPC.

The RMA 102 in the prior-art disc 100 is assigned to recording management information (recording management data) which includes information for managing changes in the recording states of the lead-in area 103, the data area 104, and the lead-out area 105, and information for managing OPC-related information. The recording management information is recorded on the RMA 102 for every RMD (recording management data) block. One RMD block has a recording management information piece, and error detection and correction code words therefor.

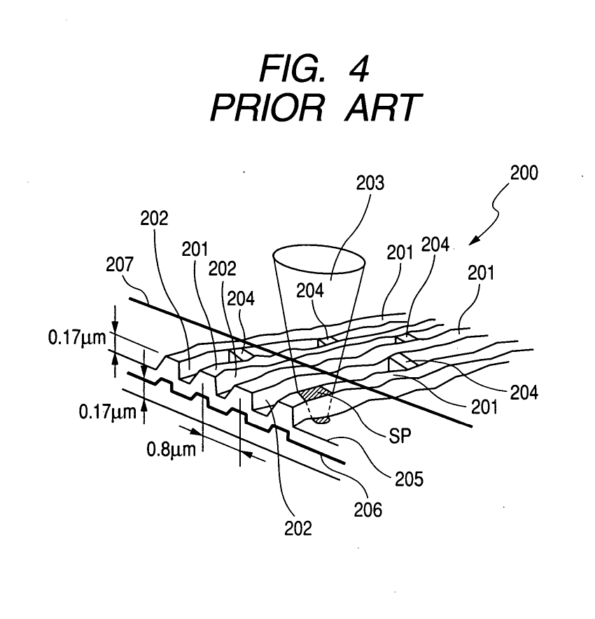

FIG. 4 shows a second prior-art DVD-R or DVD-RW 200. The prior-art disc 200 may be similar to the prior-art disc 100 of FIG. 1 in recording area structure. The prior-art disc 200 includes an information recording layer 205, a metal-deposited layer 206, and a protective layer 207. In FIG. 4, the metal-deposited layer 206 extends below the information recording layer 205. The protective layer 207 covers the information recording layer 205.

The information recording layer 205 has groove tracks 201 and land tracks 202 alternating with each other as viewed along a radial direction of the prior-art disc 200. It should be noted that FIG. 4 illustrates the groove tracks 201 and the land tracks 202 in an opposite manner. The groove tracks 201 are main information recording tracks. Two land tracks 202 adjoining one groove track 201 are used for guiding a laser beam 203 to the groove track 201. Thus, the laser beam 203 is focused into a spot SP on the groove track 201.

On-disc address information is recorded on the prior-art disc 200 as land pre-pits (LPP) 204 in the land tracks 202 at the pre-formatting stage during the manufacture of the prior-art disc 200. A prior-art drive apparatus for the prior-art disc 200 reads out the on-disc address information from the LPP 204. During the recording of a signal on the prior-art disc 200, the prior-art drive apparatus controls a currently accessed position on the prior-art disc 200 in response to the read-out LPP address information.

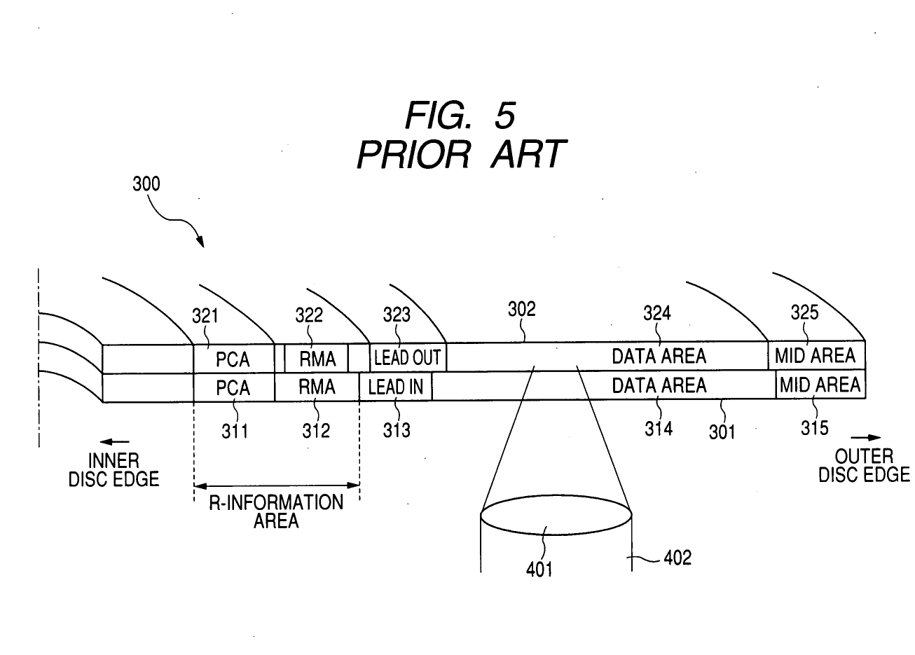

FIG. 5 shows a third prior-art DVD-R 300. The prior-art disc 300 is of a two-layer single-sided type. The prior-art disc 300 has a laminated structure including a first recording layer 301 and a second recording layer 302 which are successively arranged in an axial direction of a laser beam 402 (or an axial direction of the disc 300). The first recording layer 301 is closer to an optical pickup (a recording and reproducing head) of a prior-art optical-disc drive apparatus than the second recording layer 302 is. An objective lens 401 in the optical pickup focuses the laser beam 402 onto either the first recording layer 301 or the second recording layer 302. The laser beam 402 reaches the second recording layer 302 after passing through the first recording layer 301.

The first recording layer 301 is divided into a PCA 311, an RMA 312, a lead-in area 313, a data area 314, and a middle area 315 which are successively arranged in that order as viewed along a radial direction from the inner disc edge toward the outer disc edge. The PCA 311 and the RMA 312 constitute an R-information area. The second recording layer 302 is divided into a PCA 321, an RMA 322, a lead-out area 323, a data area 324, and a middle area 325 which are successively arranged in that order as viewed along a radial direction from the inner disc edge toward the outer disc edge. The PCA 321 and the RMA 322 constitute an R-information area. The PCAs 311 and 321 are substantially equal in size, and align with each other. In other words, the PCAs 311 and 321 substantially entirely overlap each other.

The first recording layer 301 is similar to the recording layer in the prior-art disc 100 of FIG. 1 except that the middle area 315 replaces the lead-out area 105 (see FIG. 1). The second recording layer 302 is similar to the first recording layer 301 except that the lead-out area 323 replaces the lead-in area 313. The first recording layer 301 is scanned in a direction from the inner disc edge toward the outer disc edge during the recording of data thereon. The second recording layer 302 is scanned in a direction from the outer disc edge toward the inner disc edge during the recording of data thereon.

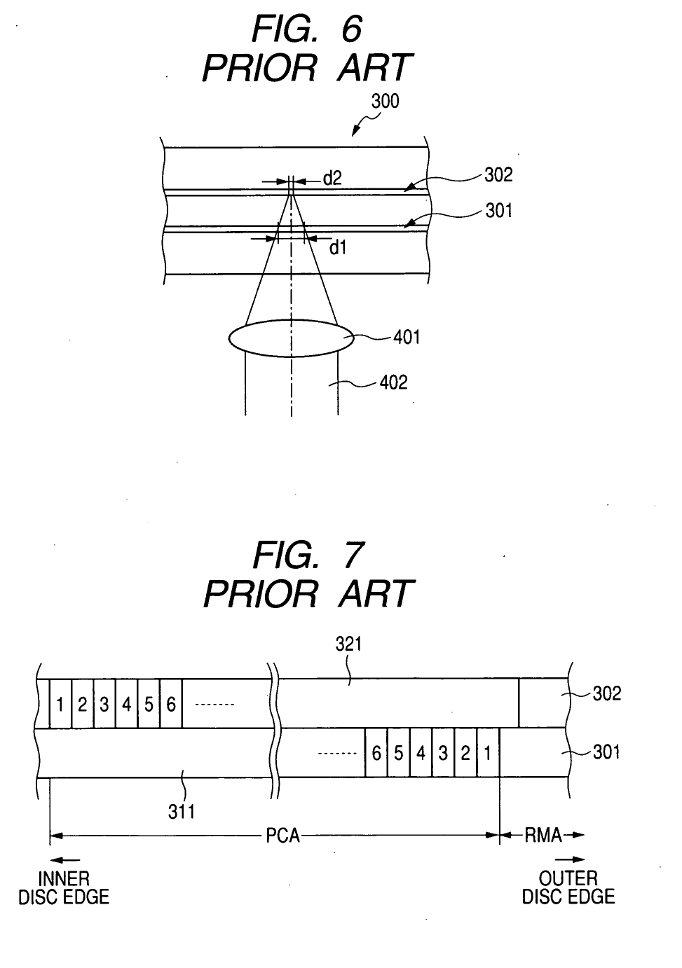

With reference to FIG. 6, the laser beam 402 which is emitted from a light source in the optical pickup of the prior-art drive apparatus passes through the objective lens 401 before reaching the prior-art disc 300. During the recording of data on the second recording layer 302, the objective lens 401 focuses the laser beam 402 on the second recording layer 302. In this case, the laser beam 402 passes through the objective lens 401 and the first recording layer 301 before reaching the second recording layer 302. Thus, conditions of the recording of data on the second recording layer 302 depend on whether a portion of the first recording layer 301 through which the laser beam 402 passes is used or unused, that is, whether or not the portion of the first recording layer 301 already has recorded data.

In the case where the laser beam 402 is controlled to always pass through a used portion of the first recording layer 301 during the recording of data on the second recording layer 302, conditions of the data recording can be constant. In this case, as shown in FIG. 6, the diameter d1 of the laser beam 402 in the first recording layer 301 is greater than its diameter d2 at the second recording layer 302. Therefore, a signal recordable area in the second recording layer 302 is narrow relative to a used area in the first recording layer 301. The signal recordable area in the second recording layer 302 is narrower when errors (tolerance) in the structures of the first and second recording layers 301 and 302 are considered. Specifically, the information recording position on each of the recording layers 301 and 302 is controlled in response to LPP address information recorded thereon. Generally, there is a discrepancy between the on-disc radial position represented by a piece of the LPP address information in the first recording layer 301 and that represented by a corresponding piece of the LPP address information in the second recording layer 302. Such a discrepancy causes a narrower signal recordable area in the second recording layer 302.

The prior-art drive apparatus for the prior-art disc 300 utilizes the PCAs 311 and 321 in the following way. As shown in FIG. 7, the PCA 311 in the first recording layer 301 is divided into sections numbered “1”, “2”, “3”, . . . in a radial direction from the outer disc edge toward the inner disc edge. The prior-art drive apparatus sequentially uses the sections “1”, “2”, “3”, . . . of the PCA 311 for trial write and read. On the other hand, the PCA 321 in the second recording layer 302 is divided into sections numbered “1”, “2”, “3”, . . . in a radial direction from the inner disc edge toward the outer disc edge. The prior-art drive apparatus sequentially uses the sections “1”, “2”, “3”, . . . of the PCA 321 for the trial write and read. An inner portion of the PCA 311 in the first recording layer 301 remains unused so that the laser beam will reach the second recording layer 302 through the unused portion of the first recording layer 301 during the use of the PCA 321 in the second recording layer 302 for the trial write and read.

The trial write and read utilizing the PCA 321 decides a first optimum recording power of the laser beam for the second recording layer 302 under conditions where the laser beam reaches the PCA 321 through an unused portion of the PCA 311. The trial write and read utilizing the PCA 321 decides a second optimum recording power of the laser beam for the second recording layer 302 under conditions where the laser beam reaches the PCA 321 through a used portion of the PCA 311. It is known that the difference between the first optimum recording power and the second optimum recording power varies from disc to disc. A signal representing this power difference is prerecorded on each prior-art disc 300.

The prior-art drive apparatus for the prior-art disc 300 performs the trial write and read by utilizing the PCA 321, and thereby decides an optimum recording power of the laser beam for the second recording layer 302 while applying the laser beam to the PCA 321 through an unused portion of the PCA 311. The prior-art drive apparatus reads out, from the prior-art disc 300, the signal representing the power difference. Then, the prior-art drive apparatus subtracts the power difference from the decided optimum recording power to calculate an optimum recording power of the laser beam for the second recording layer 302 which is applied to signal recording on the second recording layer 302 under conditions where the laser beam reaches the second recording layer 302 through a used portion of the first recording layer 301.

### First Embodiment

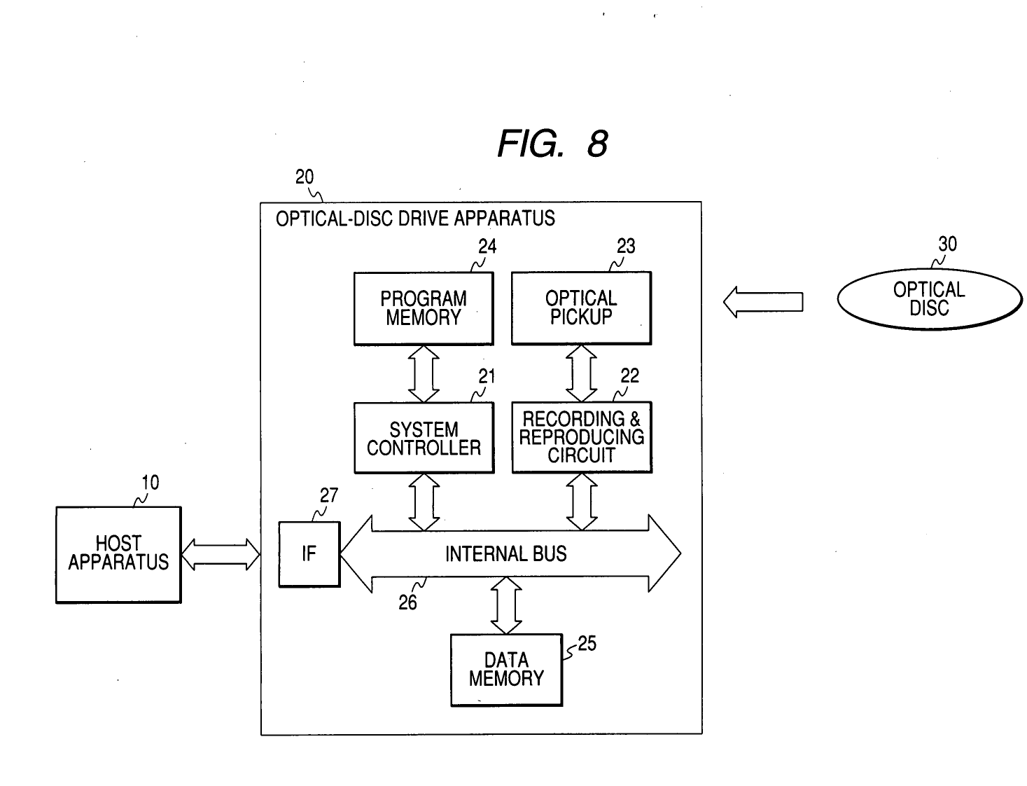

FIG. 8 shows an information recording and reproducing system including a host apparatus 10, an optical-disc drive apparatus 20, and an optical disc 30. The optical-disc drive apparatus 20 and the optical disc 30 are in a first embodiment of this invention. The host apparatus 10 and the optical-disc drive apparatus 20 are connected with each other. The optical disc 30 can be inserted into and ejected from the body of the optical-disc drive apparatus 20.

The optical disc 30 is of a two-layer single-sided structure similar to that in FIG. 5. The optical disc 30 uses a digital versatile disc rewritable (DVD-RW). Specifically, the optical disc 30 includes a laminate of two recording layers each having a PCA (a trial write area), an RMA, a data area, and other areas. The optical disc 30 is formed with a central opening, and thus has an inner circumferential edge in addition to an outer circumferential edge. The optical disc 30 has prerecorded LPP (land pre-pit) address information.

The host apparatus 10 includes, for example, a personal computer. The host apparatus 10 can instruct the optical-disc drive apparatus 20 to record information on the optical disc 30 or reproduce information therefrom. It should be noted that the host apparatus 10 and the optical-disc drive apparatus 20 may be located in a common casing. For example, the host apparatus 10 and the optical-disc drive apparatus 20 are combined to form an optical-disc recorder or an optical-disc recordable player.

The optical-disc drive apparatus 20 has not only the function of recording information on the optical disc 30 but also the function of reproducing information therefrom. The optical-disc drive apparatus 20 reproduces the LPP address information from the optical disc 30. During the recording of information on the optical disc 30 or the reproduction of information therefrom, the optical-disc drive apparatus 20 controls the currently-accessed position on the optical disc 30 according to the reproduced LPP address information.

The optical-disc drive apparatus 20 includes a system controller 21, a recording and reproducing circuit 22, an optical pickup (a recording and reproducing head) 23, a program memory 24, a data memory 25, an internal bus 26, and an interface 27.

The system controller 21, the recording and reproducing circuit 22, the data memory 25, and the interface 27 are bidirectionally connected by the internal bus 26. The program memory 24 is connected with the system controller 21. The optical pickup 23 is connected with the recording and reproducing circuit 22. The optical pickup 23 can optically access the optical disc 30 which is placed at its normal position within the body of the optical-disc drive apparatus 20. During the access to the optical disc 30, the optical pickup 23 applies a laser beam thereto and receives a reflected laser beam therefrom. The interface 27 is connected with the host apparatus 10.

The system controller 21 includes a signal processor or a CPU. The system controller 21 acts to control the whole of the optical-disc drive apparatus 20 according to a control program (a computer program). The recording and reproducing circuit 22 implements writing and reading information in and from the optical disc 30 via the optical pickup 23. The program memory 24 stores the control program for the system controller 21. Data to be recorded on the optical disc 30, data reproduced from the optical disc 30, and management information can be written into and read out from the data memory 25, and temporarily stored therein. The optical pickup 23 optically writes and reads data into and from the optical disc 30 while applying the laser beam thereto. The interface 27 connects the host apparatus 10 and the internal bus 26.

The recording and reproducing circuit 22 and the optical pickup 23 cooperate to write and read contents information and management information in and from the optical disc 30. In addition, the recording and reproducing circuit 22 and the optical pickup 23 cooperate to implement trial write and read with respect to the optical disc 30. The trial write and read is also referred to as the OPC (optimum power control) procedure.

The system controller 21, the recording and reproducing circuit 22, the optical pickup 23, the program memory 24, the data memory 25, the internal bus 26, and the interface 27 in the optical-disc drive apparatus 20 constitute a computer system which operates according to the control program stored in the program memory 24. Therefore, the optical-disc drive apparatus 20 operates in accordance with the control program. The control program is designed to enable the optical-disc drive apparatus 20 and the devices 21-27 therein to implement the previously-mentioned operation steps and also operation steps indicated hereafter.

The optical disc 30 is of a phase change type. Each of the recording layers in the optical disc 30 changes between a crystalline state and an amorphous state according to information recorded thereon. The state change (phase change) is reversible.

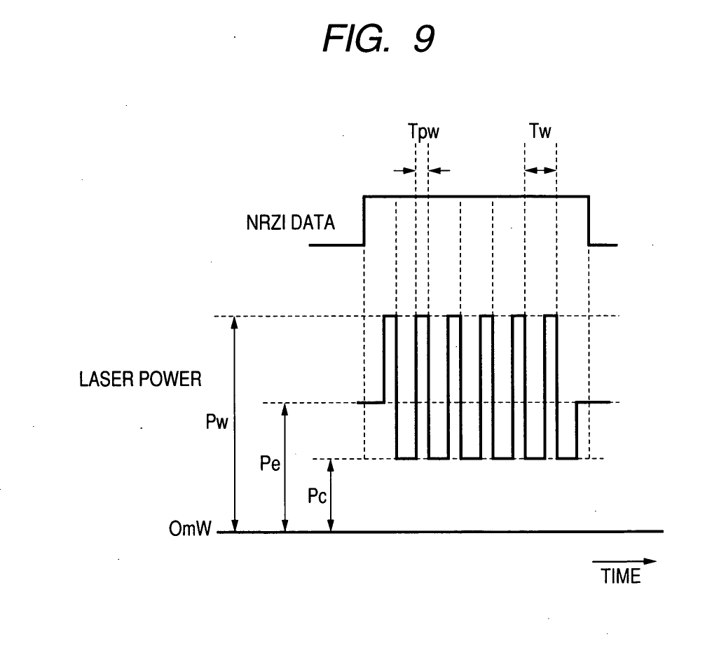

During the recording of information on the optical disc 30, the laser beam applied to the optical disc 30 from the optical pickup 23 has a multi-pulse-train waveform such as shown in FIG. 9. The laser beam is modulated by the optical-disc drive apparatus 20 (the optical pickup 23) in accordance with NRZI data to be recorded. A drive pulse train occurs in the waveform of the laser beam in accordance with the logic state of the NRZI data.

With reference to FIG. 9, while the NRZI data is in its low level state, the laser beam is controlled by the optical-disc drive apparatus 20 (the optical pickup 23) to continuously take an erasing power level Pe. While the NRZI data is in its high level state, the laser beam is controlled by the optical-disc drive apparatus 20 (the optical pickup 23) to take a drive pulse train and alternate between a recording power level Pw and a cooling power level Pc. The recording power level Pw is higher than the erasing power level Pe. The cooling power level Pc is lower than the erasing power level Pe. Pulses in the drive pulse train are spaced at intervals equal to a channel clock period Tw. The pulses in the drive pulse train have a same width Tpw.

Accordingly, while the NRZI data is in its high level state, the laser beam alternates between the recording power level Pw and the cooling power level Pc so that a portion of a recording layer in the optical disc 30 which is exposed to the laser beam is abruptly heated and cooled and thus falls into an amorphous state. While the NRZI data is in its low level state, the laser beam continuously takes the erasing power level Pe so that a portion of a recording layer in the optical disc 30 which is exposed to the laser beam is annealed at a low temperature and thus falls into a crystalline state.

The optical-disc drive apparatus 20 employs a similar waveform of the laser beam to record NRZI data over a used portion of the data area of a recording layer in the optical disc 30 on a direct overwrite basis. The trial write and read implemented by the optical-disc drive apparatus 20 with respect to the optical disc 30 is designed to include the following procedure. A used section of the PCA of a recording layer in the optical disc 30 can be used for the trial write and read again after being subjected to DC erasure employing the laser beam with a prescribed erasing power level (equal to, for example, the previously-indicated erasing power level Pe). It is preferable to avoid the use of direct overwrite in the trial write and read since the direct overwrite might adversely affect an optimum recording power decided by the trial write and read.

Preferably, the optical-disc drive apparatus 20 records user data first on the data area of a first recording layer in the optical disc 30. After the data area of the first recording layer has been fully occupied by the recorded user data, the optical-disc drive apparatus 20 records later user data on the data area of a second recording layer in the optical disc 30. Therefore, during the recording of the user data on the data area of the second recording layer, the laser beam passes through the used portion of the first recording layer before reaching the second recording layer.

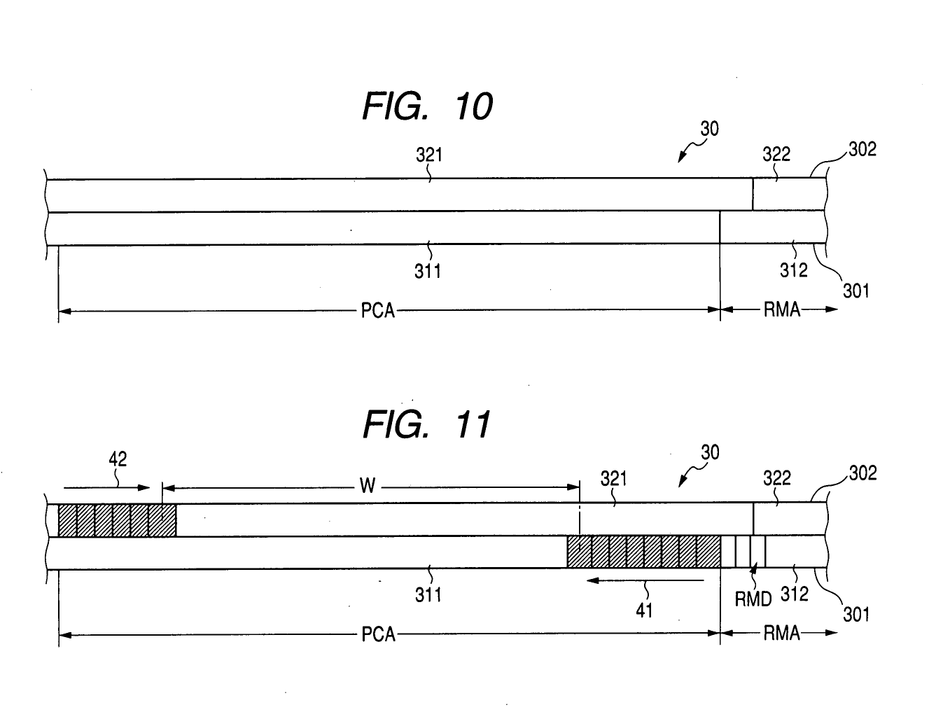

With reference to FIG. 10, the optical disc 30 includes a laminate of a first recording layer 301 and a second recording layer 302 which overlap as viewed in the axial direction of the optical disc 30 (or the axial direction of the laser beam emitted from the optical pickup 23). The first recording layer 301 has a PCA 311 and an RMA 312 successively arranged in that order as viewed in a radial direction from the inner disc edge toward the outer disc edge. The PCA 311 and the RMA 312 constitute an R-information area. The second recording layer 302 has a PCA 321 and an RMA 322 successively arranged in that order as viewed in the radial direction from the inner disc edge toward the outer disc edge. The PCA 321 and the RMA 322 constitute an R-information area. The PCAs 311 and 321 substantially align and overlap with each other as viewed in the axial direction of the optical disc 30 (or the axial direction of the laser beam emitted from the optical pickup 23). The RMAs 312 and 322 substantially align and overlap with each other as viewed in the axial direction of the optical disc 30 (or the axial direction of the laser beam emitted from the optical pickup 23). In FIG. 10, the R-information areas are in their initial states or states occurring after the whole of the PCAs 311 and 321 has been subjected to the DC erasure.

The optical-disc drive apparatus 20 repetitively implements the trial write and read (the OPC procedure) by utilizing each of the PCAs 311 and 321 in the first and second recording layers 301 and 302. The repetitive trial write and read for the first recording layer 301 is as follows. Firstly, the optical-disc drive apparatus 20 uses an outermost prescribed-size section (portion) of the PCA 311 for the trial write and read. As a result, the PCA 311 is divided into a used zone and an unused zone. Secondly, the optical-disc drive apparatus 20 uses an outermost prescribed-size section of the unused zone in the PCA 311 for the trial write and read. As a result, the used zone in the PCA 311 expands while the unused zone therein contracts. Thirdly, the optical-disc drive apparatus 20 uses an outermost prescribed-size section of the unused zone in the PCA 311 for the trial write and read. Such steps are iterated. The repetitive trial write and read for the second recording layer 302 is as follows. Firstly, the optical-disc drive apparatus 20 uses an innermost prescribed-size section (portion) of the PCA 321 for the trial write and read. As a result, the PCA 321 is divided into a used zone and an unused zone. Secondly, the optical-disc drive apparatus 20 uses an innermost prescribed-size section of the unused zone in the PCA 321 for the trial write and read. As a result, the used zone in the PCA 321 expands while the unused zone therein contracts. Thirdly, the optical-disc drive apparatus 20 uses an innermost prescribed-size section of the unused zone in the PCA 321 for the trial write and read. Such steps are iterated.

FIG. 11 shows the conditions of the R-information areas in the first and second recording layers 301 and 302 which occur after the OPC procedure has been performed by utilizing each of the PCAs 311 and 321 several times. In FIG. 11, the hatched rectangles denote PCA sections which have been used for the OPC procedure. With reference to FIG. 11, each of the PCAs 311 and 321 is virtually divided into portions or sections successively arranged in a radial direction of the optical disc 30. Each PCA section is assigned to the single-time trial write and read, that is, the single-time OPC procedure. Thus, each PCA section has a prescribed size for accommodating test signals generated during the single-time trial write and read (the single-time OPC procedure). The optical-disc drive apparatus 20 sequentially uses the sections of the PCA 311 for the trial write and read in an order accorded with a radial direction 41 from the outer disc edge toward the inner disc edge. The optical-disc drive apparatus 20 sequentially uses the sections of the PCA 321 for the trial write and read in an order accorded with a radial direction 42 from the inner disc edge toward the outer disc edge.

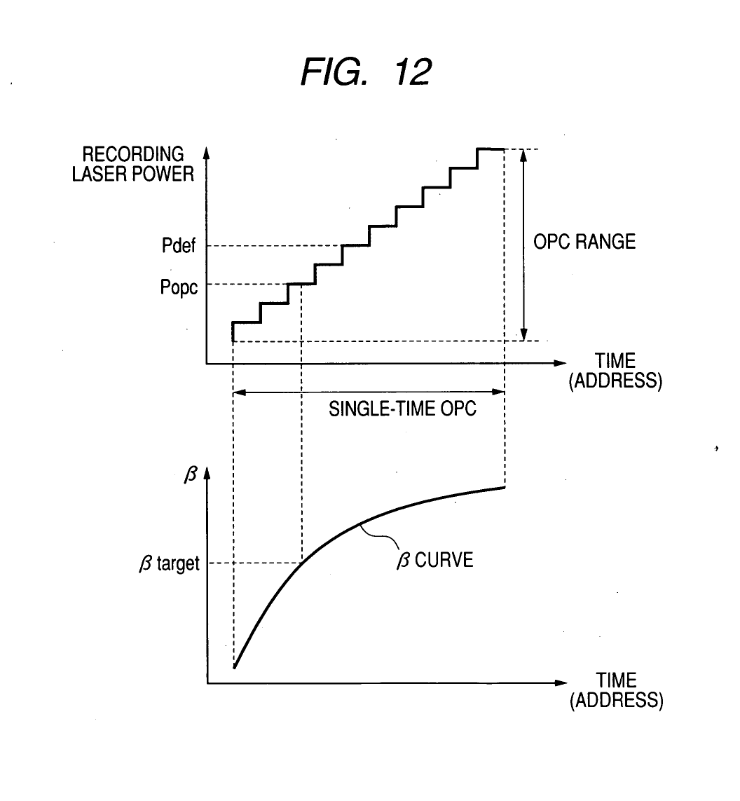

During a first stage of the single-time OPC procedure (the single-time trial write and read), the optical-disc drive apparatus 20 sequentially records test signals on a PCA section while changing the recording power of the laser beam among ten different values as shown in FIG. 12. The test signals are assigned to the different power values, respectively. During a second stage of the single-time OPC procedure, the optical-disc drive apparatus 20 sequentially reproduces the recorded test signals from the PCA section and removes DC components from the reproduced test signals to get reproduced RF signals. The optical-disc drive apparatus 20 obtains measures “β” of the evaluation of the reproduced RF signals from the waveforms thereof. Each evaluation measure “β” corresponds to the degree of the symmetry between the upper-side amplitude and the lower-side amplitude of the related RF signal. The obtained evaluation measures “β” correspond to the different power values, respectively.

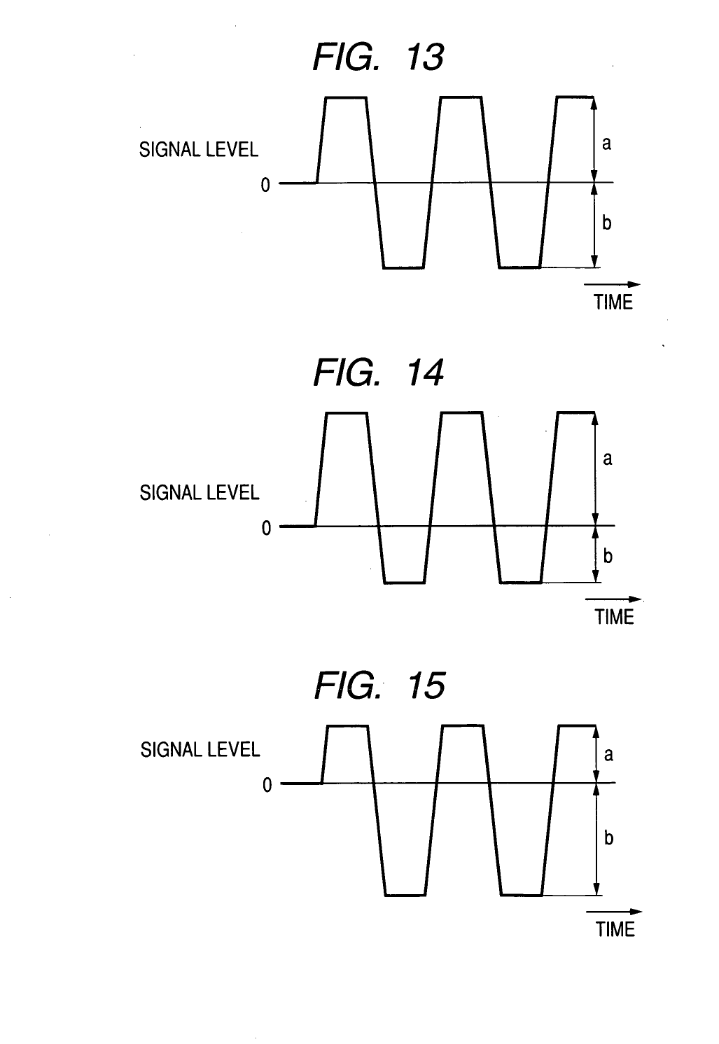

As shown in FIG. 13, a reproduced RF signal which corresponds to a proper recording laser power has substantially equal upper-side amplitude “a” and lower-side amplitude “b”, and thus has a good symmetry between the upper-side amplitude “a” and the lower-side amplitude “b”. In this case, a rectangular pulse signal resulting from comparing the reproduced RF signal with the zero level has a duty cycle of about 50%. As shown in FIG. 14, a reproduced RF signal which corresponds to an over recording laser power has a greater upper-side amplitude “a” and a smaller lower-side amplitude “b”. In this case, a rectangular pulse signal resulting from comparing the reproduced RF signal with the zero level has a duty cycle considerably different from 50%. As shown in FIG. 15, a reproduced RF signal which corresponds to an insufficient recording laser power has a smaller upper-side amplitude “a” and a greater lower-side amplitude “b”. In this case, a rectangular pulse signal resulting from comparing the reproduced RF signal with the zero level has a duty cycle considerably different from 50%.

Preferably, the optical-disc drive apparatus 20 (the recording and reproducing circuit 22) includes circuits for sensing a peak and a bottom of each reproduced RF signal to detect the upper-side amplitude “a” and the lower-side amplitude “b” thereof. Then, the optical-disc drive apparatus 20 (the system controller 21) calculates the evaluation measure “i” from the detected amplitudes “a” and “b” according to the following equation.
β=(a−b)/(a+b)

In the case of a reproduced RF signal which corresponds to a proper recording laser power (see FIG. 13), the evaluation measure “β” is substantially equal to “0”. In the case of a reproduced RF signal which corresponds to an over recording laser power (see FIG. 14), the evaluation measure “β” is considerably greater than “0”. In the case of a reproduced RF signal which corresponds to an insufficient recording laser power (see FIG. 15), the evaluation measure “β” is considerably smaller than “0”.

The optical-disc drive apparatus 20 stores a signal representing a predetermined target evaluation measure “βtarget” equal to, for example, 0.04. With reference to FIG. 12, the optical-disc drive apparatus 20 (the system controller 21) selects one from the calculated evaluation measures “β” which is substantially equal or the closest to the target evaluation measure “βtarget”. The optical-disc drive apparatus 20 (the system controller 21) designates one of the different power values, which corresponds to the selected evaluation measure “β”, as an optimum recording power Popc of the laser beam.

As shown in FIG. 12, a range covering the different power values is called an OPC range. The power value centered at the OPC range is denoted by Pdef. According to a first example, the ten different power values extend from −30% to +40% decrements or increments with respect to the center value Pdef (that is, from 70% to 140% of the center value Pdef). According to a second example, the ten different power values are spaced at 1-mW intervals and extend from −4 mW to +5 mW decrements or increments with respect to the center value Pdef.

With reference to FIG. 12, the optical-disc drive apparatus 20 (the system controller 21) virtually generates a second-order “β” curve by connecting the calculated evaluation measures “β” in the coordinate system using a time domain or an address domain. The generated “β” curve has a correspondence with the ten different power values. By referring to the relation between the generated “β” curve and the ten different power values, the optical-disc drive apparatus 20 finds one from the ten different power values which corresponds to the target evaluation measure “βtarget”. The optical-disc drive apparatus 20 (the system controller 21) regards the found power value as an optimum recording power Popc of the laser beam.

The optimum recording power Popc tends to slightly vary in accordance with a temperature change or another condition change. Accordingly, the OPC procedure is preferably conditioned so that the optimum recording power Popc will be near the center value Pdef. Generally, the optimum recording power Popc varies from disc to disc. Thus, it is preferable to set the optimum recording power Popc together with a laser pulse width (a write strategy) for each optical disc type.

The optical-disc drive apparatus 20 decides an optimum erasing power of the laser beam. According to a first example, the optical-disc drive apparatus 20 decides an optimum erasing power similarly to the decision of the optimum recording power Popc. According to a second example, the optical-disc drive apparatus 20 (the system controller 21) multiplies the optimum recording power Popc by a predetermined constant to get an optimum erasing power. In this case, it is unnecessary to perform the trial write and read to decide the optimum erasing power.

With reference back to FIG. 11, the optical-disc drive apparatus 20 uses first the outermost section of the PCA 311 in the first recording layer 301 for the trial write and read (the OPC procedure), and then sequentially uses the second outermost section and later sections of the PCA 311 for the trial write and read. Thus, the optical-disc drive apparatus 20 sequentially uses the sections of the PCA 311 for the trial write and read in the order accorded with the radial direction 41 from the outer disc edge toward the inner disc edge. During the single-time trial write and read, a related section of the PCA 311 is scanned by the laser beam in a direction from the inner disc edge toward the outer disc edge. As previously mentioned, the hatched rectangles in FIG. 11 denote PCA sections which have been used for the trial write and read. During the single-time trial write and read, the recoding power of the laser beam is changed among the ten different values.

The optical-disc drive apparatus 20 uses first the innermost section of the PCA 321 in the second recording layer 302 for the trial write and read (the OPC procedure), and then sequentially uses the second innermost section and later sections of the PCA 321 for the trial write and read. Thus, the optical-disc drive apparatus 20 sequentially uses the sections of the PCA 321 for the trial write and read in the order accorded with the radial direction 42 from the inner disc edge toward the outer disc edge. During the single-time trial write and read, a related section of the PCA 321 is scanned by the laser beam in a direction from the outer disc edge toward the inner disc edge.

In some cases, the LPP address information can not be correctly read out from a section of the PCA 311 in the first recording layer 301 which has been used for the trial write and read, and thus which has been loaded with the test signals. When a test signal is recorded by use of the laser beam having a recording power exceeding an optimum level, recording marks wider than the groove track width are sometimes formed. Such excessively big recording marks make it difficult to correctly read out the LPP address information recorded thereabout. The optical-disc drive apparatus 20 reads out the LPP address information from the first recording layer 301 while the laser beam scans the first recording layer 301 in a direction from the inner disc edge toward the outer disc edge. As previously mentioned, the sections of the PCA 311 are sequentially used for the trial write and read in the order accorded with the radial direction 41 from the outer disc edge toward the inner disc edge. Therefore, the laser beam does not meet excessively big recording marks and hence the LPP address information continues to be correctly read out from the first recording layer 301 until the laser beam reaches a section of the PCA 311 which should be used next for the trial write and read.

During a certain time interval before a stage for generating reproduced RF signals by scanning the last used section of the PCA 311, the laser beam does not meet excessively big recording marks and hence the LPP address information continues to be correctly read out from the first recording layer 301 until the laser beam reaches the last used section of the PCA 311.

The optical-disc drive apparatus 20 reads out the LPP address information from the second recording layer 302 while the laser beam scans the second recording layer 302 in a direction from the outer disc edge toward the inner disc edge. As previously mentioned, the sections of the PCA 321 are sequentially used for the trial write and read in the order accorded with the radial direction 42 from the inner disc edge toward the outer disc edge. Therefore, the laser beam does not meet excessively big recording marks and hence the LPP address information continues to be correctly read out from the second recording layer 302 until the laser beam reaches a section of the PCA 321 which should be used next for the trial write and read.

During a certain time interval before a stage for generating reproduced RF signals by scanning the last used section of the PCA 321, the laser beam does not meet excessively big recording marks and hence the LPP address information continues to be correctly read out from the second recording layer 302 until the laser beam reaches the last used section of the PCA 321.

During a later stage in every OPC procedure (every trial write and read), the optical-disc drive apparatus 20 gets information representing the address of the currently used PCA section. The optical-disc drive apparatus 20 records the PCA-section address information on the RMA 312 in the first recording layer 301 or the RMA 322 in the second recording layer 302 as RMD (recording management data). Regarding the PCA 311 in the first recording layer 301, the PCA-section address information represents the address of the innermost circumference of the currently used PCA section. Regarding the PCA 321 in the second recording layer 302, the PCA-section address information represents the address of the outermost circumference of the currently used PCA section.

When an optical disc 30 is placed into the optical-disc drive apparatus 20 or when a prescribed instruction is issued to the optical-disc drive apparatus 20 from the host apparatus 10, the optical-disc drive apparatus 20 reads out the newest RMD from the RMA 312 or 322 for each of the first and second recording layers 301 and 302. Thereby, the optical-disc drive apparatus 20 obtains information representing the address of the last used section of the PCA 311 and also information representing the address of the last used section of the PCA 321. Preferably, the optical-disc drive apparatus 20 scans the section of the PCA 311, which extends immediately inward of the last used section represented by the obtained PCA-section address information, to detect whether or not effective RF signals are reproduced from the scanned PCA section. Similarly, the optical-disc drive apparatus 20 scans the section of the PCA 321, which extends immediately outward of the last used section represented by the obtained PCA-section address information, to detect whether or not effective RF signals are reproduced from the scanned PCA section. When effective RF signals are not reproduced from the scanned PCA section, the optical-disc drive apparatus 20 (the system controller 21) concludes that the last used section represented by the obtained PCA-section address information is true. On the other hand, when effective RF signals are reproduced from the scanned PCA section, the optical-disc drive apparatus 20 (the system controller 21) concludes that the scanned PCA section is the actual last used section. This procedure compensates for a trouble such that RMD inclusive of information representing the address of the last used PCA section fails to be recorded on the RMA 312 or 322.

With reference to FIG. 11, the optical-disc drive apparatus 20 (the system controller 21) calculates the radial distance W between the finally-decided last used section of the PCA 311 and the finally-decided last used section of the PCA 321, that is, the radial distance W between the used zone in the PCA 311 and the used zone in the PCA 321 from the addresses thereof. Then, the optical-disc drive apparatus 20 (the system controller 21) compares the calculated radial distance W with a preset threshold value Wth. The calculated radial distance W is equal to the difference between the radius of a track portion having the finally-decided last used section of the PCA 311 and the radius of a track portion having the finally-decided last used section of the PCA 321. The calculated radial distance W is expressed in units determined by the LPP address information.

Generally, bits of an LPP address information piece about a radial position on the second recording layer 302 are identical with inversions of bits of an LPP address information about the same radial position on the first recording layer 301. In this case, the bits of the LPP address information piece about the finally-decided last used section of the PCA 321 are inverted. Then, the difference of the inversion of the LPP address information piece about the finally-decided last used section of the PCA 321 from the LPP address information piece about the finally-decided last used section of the PCA 311 is computed. The computed difference is used as the calculated radial distance W.

Preferably, during every single-time trial write and read (every single-time OPC procedure), the system controller 21 stores, into the data memory 25, address information about the PCA section currently used for the trial write and read. In this case, the calculation of the radial distance W may use the PCA-section address information in the data memory 25 instead of the RMD read out from the RMA 312 or 322.

The preset threshold value Wth is chosen in the light of (1) a manufacturing tolerance for the optical disc 30 and (2) the diameter of the laser beam in the first recording layer 301 which is focused on the second recording layer 302. During the recording of data on the second recording layer 302, the laser beam passes through the first recording layer 301 and then reaches the second recording layer 302 while the objective lens in the optical pickup 23 focuses the laser beam on the second recording layer 302 (see FIG. 6). In this case, the diameter d1 of the laser beam in the first recording layer 301 is considerably greater than its diameter d2 at the second recording layer 302 (see FIG. 6). The laser beam diameter d1 is equal to about 60 μm.

The first and second recording layers 301 and 302 are sometimes different in eccentricity due to a certain factor in disc manufacture. A groove-track radial position represented by an LPP address information piece recorded on the first recording layer 301 and a groove-track radial position represented by an inversion of that LPP address information piece which is recorded on the second recording layer 302 are sometimes different due to a given factor in disc manufacture. Such an eccentricity difference and a radial position difference are defined as a tolerance for the optical disc 30. The disc tolerance is equal to about 80 μm. A reference for the preset threshold value Wth is equal to 140 μm, that is, the sum of 60 μm (the laser beam diameter d1) and 80 μm (the disc tolerance). The 140-μm reference is converted into an address difference. The preset threshold value Wth is equal to the address difference plus a predetermined margin of several μm.

As previously mentioned, the optical-disc drive apparatus 20 (the system controller 21) compares the calculated radial distance W with the preset threshold value Wth. When the comparison result indicates that the calculated radial distance W is greater than the preset threshold value Wth, the optical-disc drive apparatus 20 does not process the PCAs 311 and 321.

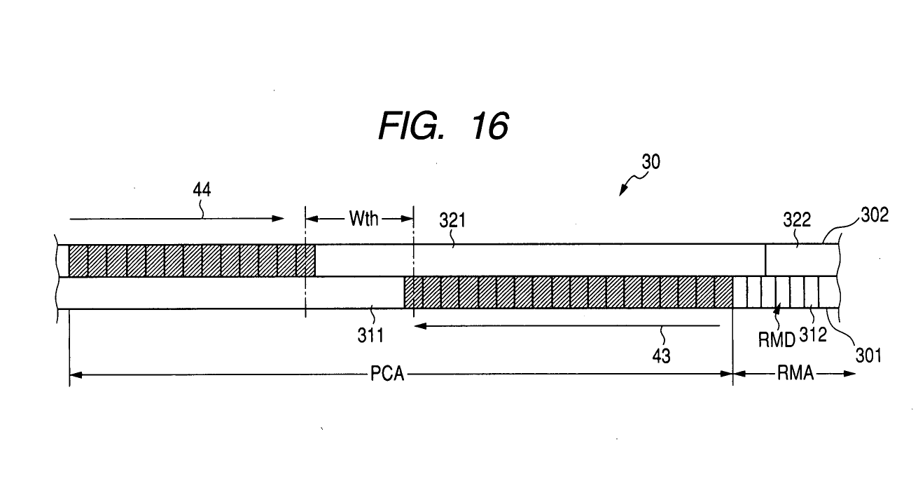

FIG. 16 shows the conditions of the R-information areas in the first and second recording layers 301 and 302 which occur after the OPC procedure has further been performed by utilizing each of the PCAs 311 and 321 several times from the conditions in FIG. 11. In FIG. 16, the hatched rectangles denote PCA sections which have been used for the OPC procedure. Specifically, the optical-disc drive apparatus 20 have sequentially used the sections of the PCA 311 for the trial write and read in the order accorded with a radial direction 43 from the outer disc edge toward the inner disc edge. The optical-disc drive apparatus 20 have sequentially used the sections of the PCA 321 for the trial write and read in the order accorded with a radial direction 44 from the inner disc edge toward the outer disc edge. In FIG. 16, the calculated radial distance W is equal to the preset threshold value Wth.

As previously mentioned, the optical-disc drive apparatus 20 (the system controller 21) compares the calculated radial distance W with the preset threshold value Wth. When the comparison result indicates that the calculated radial distance W is equal to or smaller than the preset threshold value Wth, the optical-disc drive apparatus 20 subjects the PCAs 311 and 321 to the DC erasure. During the DC erasure, the optical-disc drive apparatus 20 (the optical pickup 23) scans all the used sections of the PCAs 311 and 321 by the laser beam having a prescribed erasing power. As result, the whole of the PCAs 311 and 321 is returned to the unused state (see FIG. 10).

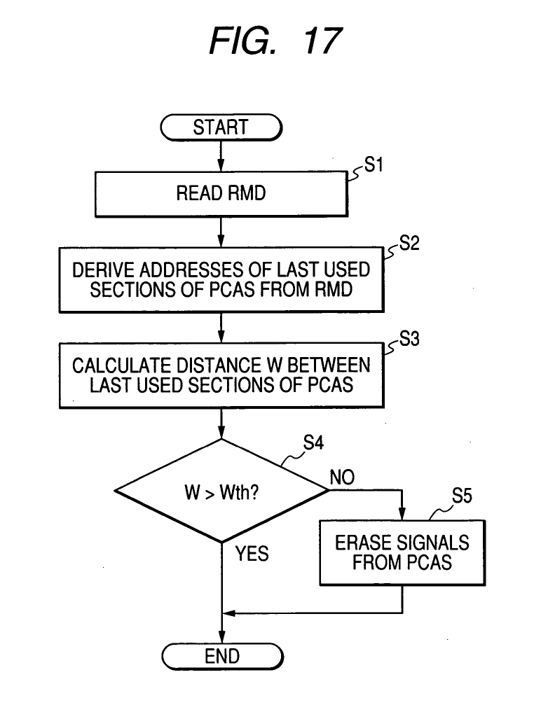

FIG. 17 is a flowchart of a segment of the control program for the optical-disc drive apparatus 20. The program segment in FIG. 17 is started when an optical disc 30 is placed into the optical-disc drive apparatus 20 or when a prescribed instruction is issued to the optical-disc drive apparatus 20 from the host apparatus 10.

As shown in FIG. 17, a first step S1 of the program segment reads out the newest RMD from the RMA 312 or 322 for each of the first and second recording layers 301 and 302. The step S1 may retrieve the newest RMD from the data memory 25.

A step S2 following the step S1 derives, from the read-out RMD, the address of the last used section of the PCA 311 and also the address of the last used section of the PCA 321.

A step S3 subsequent to the step S2 calculates the radial distance W between the last used section of the PCA 311 and the last used section of the PCA 321 (that is, the radial distance W between the used zone in the PCA 311 and the used zone in the PCA 321) from the derived addresses thereof.

A step S4 following the step S3 compares the calculated radial distance W with the preset threshold value Wth. When the calculated radial distance W is equal to or smaller than the preset threshold value Wth, the program advances from the step S4 to a step S5. Otherwise, the program exits from the step S4, and then the current execution cycle of the program segment ends.

The step S5 subjects the PCAs 311 and 321 to the DC erasure to return them to the unused state. Specifically, the step S5 erases all the recorded test signals from the PCAs 311 and 321. After the step S5, the current execution cycle of the program segment ends.

As previously mentioned, the optical-disc drive apparatus 20 sequentially uses the sections of the PCA 311 in the first recording layer 301 for the trial write and read in the order accorded with the radial direction from the outer disc edge toward the inner disc edge. The optical-disc drive apparatus 20 sequentially uses the sections of the PCA 321 in the second recording layer 302 for the trial write and read in the order accorded with the radial direction from the inner disc edge toward the outer disc edge. When the calculated radial distance W between the used zone in the PCA 311 and the used zone in the PCA 321 becomes equal to or smaller than the preset threshold value Wth, the optical-disc drive apparatus 20 subjects the PCAs 311 and 321 inclusive of their used zones to the DC erasure. Thereafter, the optical-disc drive apparatus 20 sequentially reuses the sections of the PCA 311 in the first recording layer 301 for the trial write and read in the order accorded with the radial direction from the outer disc edge toward the inner disc edge. The optical-disc drive apparatus 20 sequentially reuses the sections of the PCA 321 in the second recording layer 302 for the trial write and read in the order accorded with the radial direction from the inner disc edge toward the outer disc edge.

It is possible to prevent only one or some of the sections of the PCA 311 or 321 from being more frequently and concentratedly used for the trial write and read than the other sections. Thus, it is possible to increase the maximum number of times the reliable and accurate trial write and read (the reliable and accurate OPC procedure) can be performed by utilizing the PCA 311 or 321 until the PCA 311 or 321 deteriorates into an unacceptable range. This results in an increased maximum number of times of signal rewriting with respect to the optical disc 30.

As previously mentioned, the LPP address information continues to be correctly read out from the first recording layer 301 or the second recording layer 302 until the laser beam reaches a section of the PCA 311 or 321 which should be used next for the trial write and read. The correct read-out of the LPP address information allows the next trial write and read to be performed by utilizing an accurately-positioned section of the PCA 311 or 321.

During the trial write and read utilizing the PCA 321 in the second recording layer 302, the laser beam passes through the erased zone (the unused zone) in the first recording layer 301 and then reaches the PCA 321 in the second recording layer 302. Therefore, it is possible to stably decide an optimum recording power of the laser beam for the second recording layer 302.

During the recording of a signal on the data area in the second recording layer 302, the optical-disc drive apparatus 20 (the optical pickup 23) applies the laser beam to the second recording layer 302 through a used zone in the first recording layer 301.

There is a certain difference between an optimum recording power of the laser beam focused on the second recording layer 302 through a used zone in the first recording layer 301 and that through an erased zone (an unused zone) in the first recording layer 301. Such a power difference varies from disc to disc. Information representing the power difference is prerecorded on the optical disc 30. The optical-disc drive apparatus 20 reads out the power difference information from the optical disc 30. Then, the optical-disc drive apparatus 20 (the system controller 21) adds the obtained power difference to the optimum recording power for the second recording layer 302, which has been decided by the OPC procedure, to calculate a final optimum recording power of the laser beam for the signal recording on the data area in the second recording layer 302.

It should be noted that the first used section in the PCA 311 of the first recording layer 301 may be spaced radially from the outer edge of the PCA 311. Similarly, the first used section in the PCA 321 of the second recording layer 302 may be spaced radially from the inner edge of the PCA 321.

When the calculated radial distance W between the used zone in the PCA 311 and the used zone in the PCA 321 becomes equal to or smaller than the preset threshold value Wth, the optical-disc drive apparatus 20 may subject only selected one or ones among the used sections in the PCAs 311 and 321 to the DC erasure. In this case, one or more used sections in the PCAs 311 and 321 remain in the used state. Preferably, a used section or sections in the PCA 311 which remain in the used state are located in an outer region in the PCA 311. Preferably, a used section or sections in the PCA 321 which remain in the used state are located in an inner region in the PCA 321.

The optical-disc drive apparatus 20 (the system controller 21) may read out the newest RMD from the RMA 312 or 322 for each of the first and second recording layers 301 and 302 while being released from a writing instruction and a reading instruction issued by the host apparatus 10.

### Second Embodiment

A second embodiment of this invention is similar to the first embodiment thereof except for design changes described hereafter.

FIG. 18 shows the conditions of the R-information areas in the first and second recording layers 301 and 302 which occur after the OPC procedure has been performed by utilizing each of the PCAs 311 and 321 several times. There are a used zone 51 in the PCA 311 and a used zone 52 in the PCA 321.

When an optical disc 30 is placed into the optical-disc drive apparatus 20 or when a prescribed instruction is issued to the optical-disc drive apparatus 20 from the host apparatus 10, the optical-disc drive apparatus 20 reads out the newest RMD from the RMA 312 or 322 for each of the first and second recording layers 301 and 302. Thereby, the optical-disc drive apparatus 20 obtains information representing the address of the last used section of the PCA 311 and also information representing the address of the last used section of the PCA 321. Preferably, the optical-disc drive apparatus 20 scans the section of the PCA 311, which extends immediately inward of the last used section represented by the obtained PCA-section address information, to detect whether or not effective RF signals are reproduced from the scanned PCA section. Similarly, the optical-disc drive apparatus 20 scans the section of the PCA 321, which extends immediately outward of the last used section represented by the obtained PCA-section address information, to detect whether or not effective RF signals are reproduced from the scanned PCA section. When effective RF signals are not reproduced from the scanned PCA section, the optical-disc drive apparatus 20 (the system controller 21) concludes that the last used section represented by the obtained PCA-section address information is true. On the other hand, when effective RF signals are reproduced from the scanned PCA section, the optical-disc drive apparatus 20 (the system controller 21) concludes that the scanned PCA section is the actual last used section.

The optical-disc drive apparatus 20 (the system controller 21) calculates the radial distance W between the finally-decided last used section of the PCA 311 and the finally-decided last used section of the PCA 321, that is, the radial distance W between the used zone 51 in the PCA 311 and the used zone 52 in the PCA 321 from the addresses thereof. Then, the optical-disc drive apparatus 20 (the system controller 21) compares the calculated radial distance W with the preset threshold value Wth.

When the comparison result indicates that the calculated radial distance W is greater than the preset threshold value Wth, the optical-disc drive apparatus 20 does not process the PCAs 311 and 321.

On the other hand, when the comparison result indicates that the calculated radial distance W is equal to or smaller than the preset threshold value Wth, the optical-disc drive apparatus 20 subjects only one of the PCAs 311 and 321 to the DC erasure. Specifically, in this case, the optical-disc drive apparatus 20 (the system controller 21) calculates the difference Wu1 between the address of the outer circumference of the PCA 311 and the address of the finally-decided last used section of the PCA 311, and the difference Wu2 between the address of the inner circumference of the PCA 321 and the address of the finally-decided last used section of the PCA 321. The difference Wu1 indicates the size of the used zone 51 in the PCA 311. The difference Wu2 indicates the size of the used zone 52 in the PCA 321. It should be noted that the places of the PCAs 311 and 321 relative to the optical disc 30 are predetermined, and information representing the predetermined PCA places in terms of LPP addresses is previously stored in a memory (the program memory 24, the data memory 25, or another memory) within the optical-disc drive apparatus 20, and that the address of the outer circumference of the PCA 311 and the address of the inner circumference of the PCA 321 are derived from the PCA place information. Then, the optical-disc drive apparatus 20 (the system controller 21) compares the calculated differences Wu1 and Wu2 to decide which of the used zones 51 and 52 in the PCAs 311 and 321 is greater in size or quantity. When the calculated difference Wu1 is greater than the calculated difference Wu2, that is, when the used zone 51 in the PCA 311 is greater than the used zone 52 in the PCA 321, the optical-disc drive apparatus 20 subjects only the PCA 311 to the DC erasure. Consequently, the PCA 311 is returned to the unused state as shown in FIG. 19. On the other hand, when the calculated difference Wu1 is not greater than the calculated difference Wu2, that is, when the used zone 51 in the PCA 311 is not greater than the used zone 52 in the PCA 321, the optical-disc drive apparatus 20 subjects only the PCA 321 to the DC erasure. Consequently, the PCA 321 is returned to the unused state.

FIG. 20 shows the conditions of the R-information areas in the first and second recording layers 301 and 302 which occur after the OPC procedure has been performed by utilizing each of the PCAs 311 and 321 several times from the conditions in FIG. 19. With reference to FIG. 20, there are a used zone 53 in the PCA 311 and a used zone 54 in the PCA 321.

As previously mentioned, when an optical disc 30 is placed into the optical-disc drive apparatus 20 or when a prescribed instruction is issued to the optical-disc drive apparatus 20 from the host apparatus 10, the optical-disc drive apparatus 20 (the system controller 21) calculates the radial distance W between the finally-decided last used section of the PCA 311 and the finally-decided last used section of the PCA 321, that is, the radial distance W between the used zone 53 in the PCA 311 and the used zone 54 in the PCA 321 from the addresses thereof. Then, the optical-disc drive apparatus 20 (the system controller 21) compares the calculated radial distance W with the preset threshold value Wth.

When the comparison result indicates that the calculated radial distance W is greater than the preset threshold value Wth, the optical-disc drive apparatus 20 does not process the PCAs 311 and 321.

On the other hand, when the comparison result indicates that the calculated radial distance W is equal to or smaller than the preset threshold value Wth, the optical-disc drive apparatus 20 subjects only one of the PCAs 311 and 321 to the DC erasure. Specifically, in this case, the optical-disc drive apparatus 20 (the system controller 21) calculates the difference Wu1 between the address of the outer circumference of the PCA 311 and the address of the finally-decided last used section of the PCA 311, and the difference Wu2 between the address of the inner circumference of the PCA 321 and the address of the finally-decided last used section of the PCA 321. The difference Wu1 indicates the size of the used zone 53 in the PCA 311. The difference Wu2 indicates the size of the used zone 54 in the PCA 321. Then, the optical-disc drive apparatus 20 (the system controller 21) compares the calculated differences Wu1 and Wu2 to decide which of the used zones 53 and 54 in the PCAs 311 and 321 is greater in size or quantity. When the calculated difference Wu1 is not greater than the calculated difference Wu2, that is, when the used zone 53 in the PCA 311 is not greater than the used zone 54 in the PCA 321, the optical-disc drive apparatus 20 subjects only the PCA 321 to the DC erasure. Consequently, the PCA 321 is returned to the unused state as shown in FIG. 21. On the other hand, when the calculated difference Wu1 is greater than the calculated difference Wu2, that is, when the used zone 53 in the PCA 311 is greater than the used zone 54 in the PCA 321, the optical-disc drive apparatus 20 subjects only the PCA 311 to the DC erasure. Consequently, the PCA 311 is returned to the unused state.

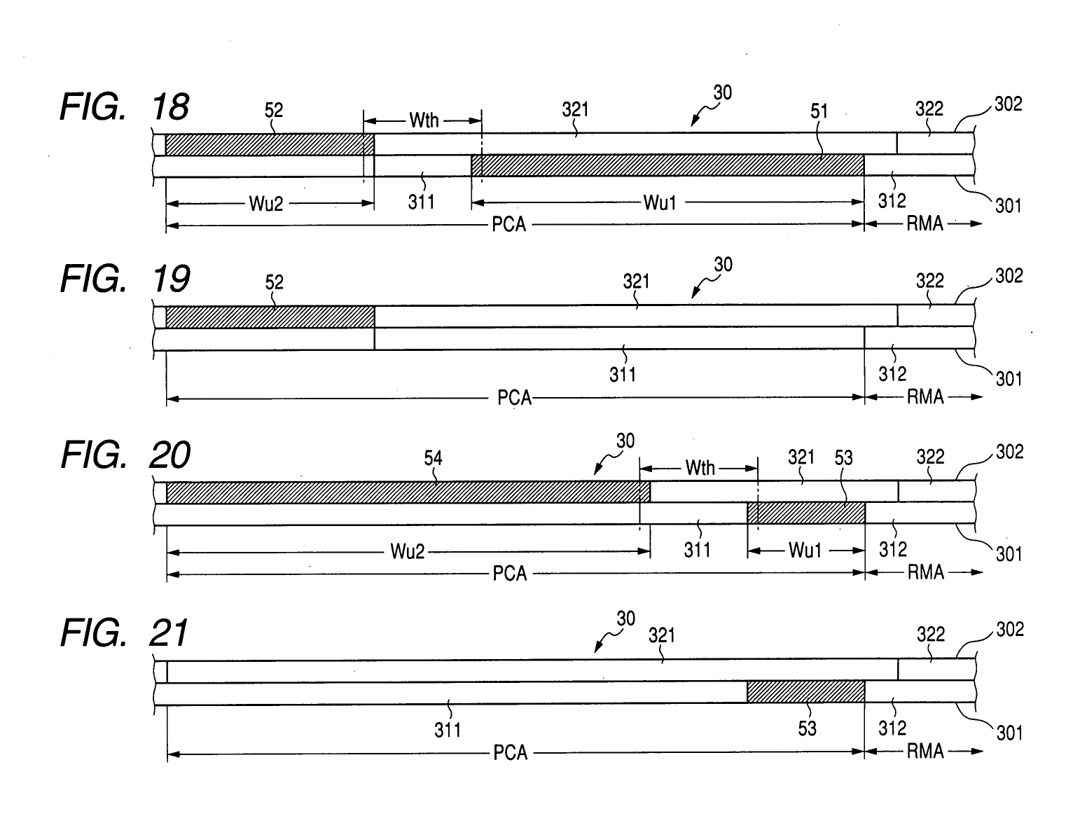

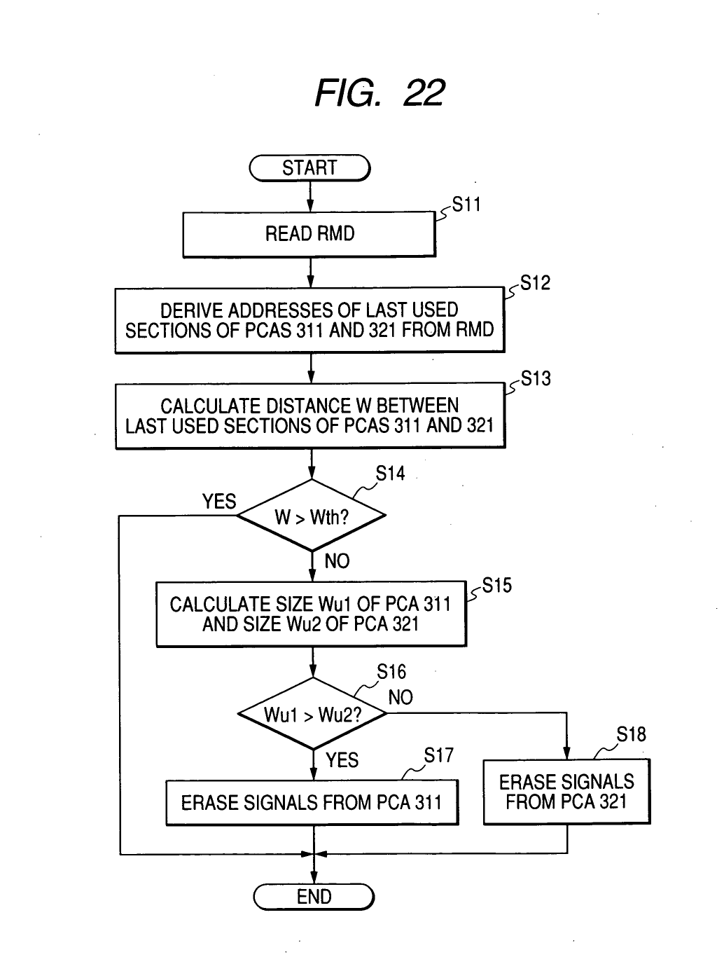

FIG. 22 is a flowchart of a segment of the control program for the optical-disc drive apparatus 20. The program segment in FIG. 22 is started when an optical disc 30 is placed into the optical-disc drive apparatus 20 or when a prescribed instruction is issued to the optical-disc drive apparatus 20 from the host apparatus 10.

As shown in FIG. 22, a first step S11 of the program segment reads out the newest RMD from the RMA 312 or 322 for each of the first and second recording layers 301 and 302. The step S11 may retrieve the newest RMD from the data memory 25.

A step S12 following the step S11 derives, from the read-out RMD, the address of the last used section of the PCA 311 and also the address of the last used section of the PCA 321.

A step S13 subsequent to the step S12 calculates the radial distance W between the last used section of the PCA 311 and the last used section of the PCA 321 (that is, the radial distance W between the used zone in the PCA 311 and the used zone in the PCA 321) from the derived addresses thereof.

A step S14 following the step S13 compares the calculated radial distance W with the preset threshold value Wth. When the calculated radial distance W is equal to or smaller than the preset threshold value Wth, the program advances from the step S14 to a step S15. Otherwise, the program exits from the step S14, and then the current execution cycle of the program segment ends.

The step S15 calculates the difference Wu1 between the address of the outer circumference of the PCA 311 and the address of the last used section of the PCA 311, and the difference Wu2 between the address of the inner circumference of the PCA 321 and the address of the last used section of the PCA 321. The difference Wu1 corresponds to the size of the used zone in the PCA 311. The difference Wu2 corresponds to the size of the used zone in the PCA 321. It should be noted that the address of the outer circumference of the PCA 311 and the address of the inner circumference of the PCA 321 are derived from the PCA place information.

A step S16 following the step S15 compares the calculated differences Wu1 and Wu2 to decide which of the used zones in the PCAs 311 and 321 is greater in size or quantity. When the calculated difference Wu1 is greater than the calculated difference Wu2, that is, when the used zone in the PCA 311 is greater than the used zone in the PCA 321, the program advances from the step S16 to a step S17. Otherwise, the program advances from the step S16 to a step S18.

The step S17 subjects only the PCA 311 to the DC erasure to return it to the unused state. Specifically, the step S17 erases all the recorded test signals from the PCA 311. After the step S17, the current execution cycle of the program segment ends.

The step S18 subjects only the PCA 321 to the DC erasure to return it to the unused state. Specifically, the step S18 erases all the recorded test signals from the PCA 321. After the step S18, the current execution cycle of the program segment ends.

As understood from the above description, one of the PCAs 311 and 321 which has a greater used zone is subjected to the DC erasure. In some cases, the PCAs 311 and 321 are alternately subjected to the DC erasure. In other cases, one of the PCAs 311 and 321 is consecutively subjected to the DC erasure before the other is subjected thereto. Basically, sectors (sections) in each of the PCAs 311 and 321 can be used at roughly equal frequencies. Specifically, outer-side ones among the sections of the PCA 311 and inner-side ones among the sections of the PCA 321 are prevented from undergoing the test write and read and the DC erasure more frequently than sections in central regions of the PCAs 311 and 321. Thus, the outer-side ones among the sections of the PCA 311 and the inner-side ones among the sections of the PCA 321 are prevented from deteriorating earlier than the sections in the central regions of the PCAs 311 and 321.

The optical-disc drive apparatus 20 may record, on the optical disc 30, a signal representing which of the PCAs 311 and 321 is currently subjected to the DC erasure as last erased PCA information. In this case, the optical-disc drive apparatus 20 reads out the last erased PCA information from the optical disc 30, and then selects one from the PCAs 311 and 321 which differs from the PCA represented by the last erased PCA information. Thereafter, the optical-disc drive apparatus 20 subjects the selected PCA to the DC erasure when one of the PCAs 311 and 321 is required to undergo the DC erasure.

It should be noted that the first used section in the PCA 311 of the first recording layer 301 may be spaced radially from the outer edge of the PCA 311. Similarly, the first used section in the PCA 321 of the second recording layer 302 may be spaced radially from the inner edge of the PCA 321.

When the calculated radial distance W between the used zone in the PCA 311 and the used zone in the PCA 321 becomes equal to or smaller than the preset threshold value Wth, the optical-disc drive apparatus 20 may subject only selected one or ones among the used sections in the PCA 311 or 321 to the DC erasure. In this case, one or more used sections in the PCAs 311 and 321 remain in the used state. Preferably, a used section or sections in the PCA 311 which remain in the used state are located in an outer region in the PCA 311. Preferably, a used section or sections in the PCA 321 which remain in the used state are located in an inner region in the PCA 321.

The optical-disc drive apparatus 20 (the system controller 21) may read out the newest RMD from the RMA 312 or 322 for each of the first and second recording layers 301 and 302 while being released from a writing instruction and a reading instruction issued by the host apparatus 10.

### Third Embodiment

A third embodiment of this invention is similar to the first embodiment thereof except for design changes described hereafter.

FIG. 23 shows the R-information areas in the first and second recording layers 301 and 302 which are in their initial states or states occurring after the whole of the PCAs 311 and 321 has been subjected to the DC erasure.

The optical-disc drive apparatus 20 performs the OPC procedure (the trial write and read) by us of the PCA 311 in the first recording layer 301 to decide an optimum recording power of the laser beam for the first recording layer 301. Thereafter, the optical-disc drive apparatus 20 records a prescribed amount of sector-number-added dummy data on the PCA 311 from its inner edge while using the laser beam having the decided optimum recording power. The sector-number-added dummy data is of a structure basically similar to that in FIGS. 2 and 3. The sector-number-added dummy data contains dummy data instead of user data. Error detection and correction parities (error detection and correction code words) may be omitted from the sector-number-added dummy data. FIG. 24 shows the resultant conditions of the R-information areas in the first and second recording layers 301 and 302. In FIG. 24, the PCA 311 has a used zone 61 occupied by the recorded test signals, and a used zone 62 occupied by the recorded dummy data.

Each of 16 sectors constituting one ECC block loaded with the dummy data has 4-byte ID (identification data) at its head, and 2-byte IED (error detection and correction code words) therefor which immediately follows the 4-byte ID. The 4-byte ID represents a unique sector number, that is, an ID sector number which has a one-to-one correspondence with the LPP (land pre-pit) address information.

FIG. 25 shows the conditions of the R-information areas in the first and second recording layers 301 and 302 which occur after the OPC procedure has been performed by utilizing each of the PCAs 311 and 321 several times from the conditions in FIG. 24. In FIG. 25, the PCA 311 has a used zone 63 occupied by the recorded test signals, and a used zone 64 occupied by the recorded dummy data. The PCA 321 has a used zone 65 occupied by the recorded test signals.

With reference to FIG. 25, the optical-disc drive apparatus 20 records the sector-number-added dummy data on the zone 64 in the PCA 311 before performing the OPC procedure utilizing the zone 65 in the PCA 321. The positions of the zones 64 and 65 are chosen so that during the OPC procedure utilizing the zone 65, the laser beam will be focused on the second recording layer 302 after passing through the zone 64. The inner edge of the zone 64 is spaced radially inward from the inner edge of the zone 65 by a prescribed radial distance R. The outer edge of the zone 64 is spaced radially outward from the outer edge of the zone 65 by the prescribed radial distance R or greater. The prescribed radial distance R corresponds to 140 μm, that is, the sum of 60 μm (the laser beam diameter d1) and 80 μm (the disc tolerance).

As shown by the zone 63 in FIG. 25, the sections of the PCA 311 in the first recording layer 301 are sequentially used for the OPC procedure in the order accorded with a radial direction from the outer edge of the PCA 311 toward the inner edge thereof. During the single-time trial write and read, a related section of the PCA 311 is scanned by the laser beam in a direction from the inner disc edge toward the outer disc edge. The sections of the PCA 321 in the second recording layer 302 are sequentially used for the OPC procedure in the order accorded with a radial direction from the inner edge of the PCA 321 toward the outer edge thereof. During the single-time trial write and read, a related section of the PCA 321 is scanned by the laser beam in a direction from the outer disc edge toward the inner disc edge.

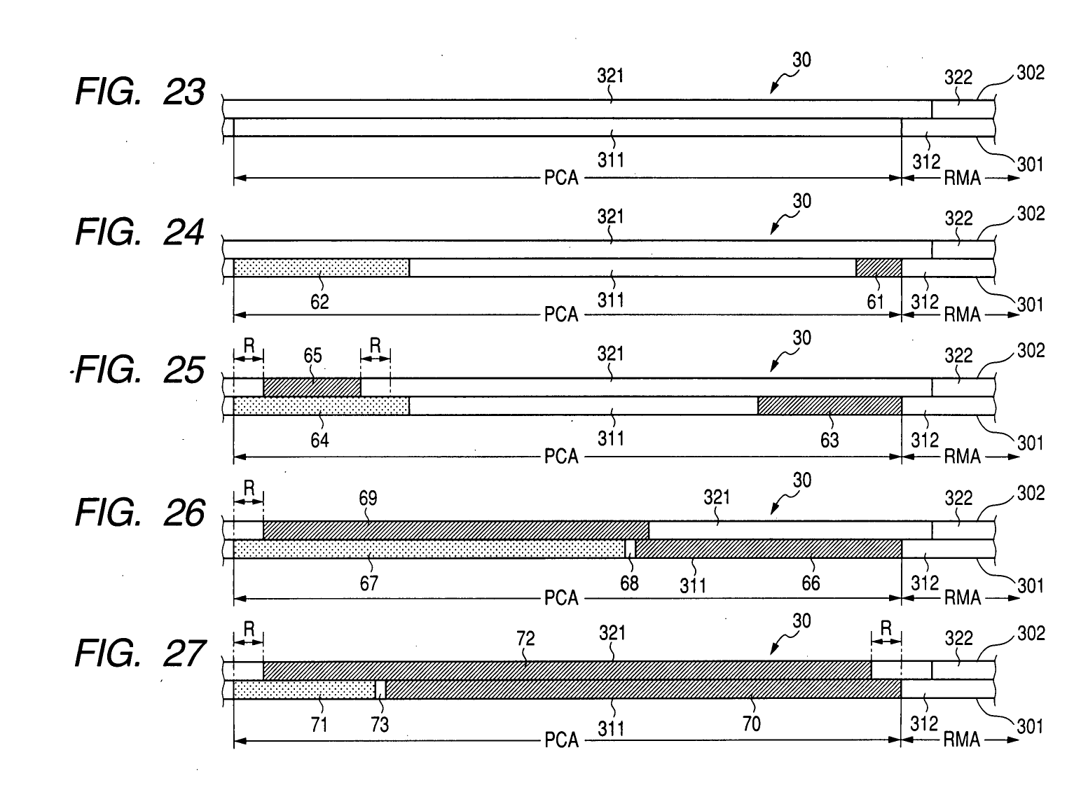

FIG. 26 shows the conditions of the R-information areas in the first and second recording layers 301 and 302 which occur after the OPC procedure has been performed by utilizing each of the PCAs 311 and 321 several times from the conditions in FIG. 25. In FIG. 26, the PCA 311 has a used zone 66 occupied by the recorded test signals, and a used zone 67 occupied by the recorded dummy data. The PCA 321 has a used zone 69 occupied by the recorded test signals. In the PCA 311, there is an unused section 68 remaining between the used zones 66 and 67. An RF signal reproduced from the unused section 68 takes “0”. Thus, the unused section 68 or the RF signal reproduced therefrom can be an accurate indicator for the inner boundary of the zone 66 which has been used for the OPC procedure.

With reference to FIG. 26, as the laser beam which is focused on the second recording layer 302 moves radially from the inner edge of the zone 69 to the outer edge thereof, the laser beam passes first through the used zone 67, second through the unused section 68, and third through the used zone 66 in the first recording layer 301. In this case, since the unused section 68 has a width (about 1 μm) extremely smaller than the 140-μm diameter of the laser beam in the first recording layer 310, the influence of the laser beam passing through the unused section 68 is negligible. Since there is only a small difference in transmittance between the used zones 66 and 67, the conditions of the laser beam reaching the second recording layer 302 through the used zone 66 in the first recording layer 301 are similar to those through the used zone 67 in the first recording layer 301.

FIG. 27 shows the conditions of the R-information areas in the first and second recording layers 301 and 302 which occur after the OPC procedure has been performed by utilizing each of the PCAs 311 and 321 several times from the conditions in FIG. 26.

With reference to FIGS. 26 and 27, the optical-disc drive apparatus 20 subjects an outer part of the used zone 67 to the DC erasure before performing the OPC procedure utilizing the PCA 311. Thus, the used zone 67 contracts to a used zone 71 (see FIG. 27) while the used zone 66 expands to a used zone 70 (see FIG. 27). In FIG. 27, there is an unused section 73 remaining between the used zones 70 and 71. The PCA 321 has a used zone 72 occupied by the recorded test signals. The used zone 72 extends over almost the whole of the PCA 321. The inner edge of the zone 72 is spaced radially outward from the inner edge of the PCA 311 by the prescribed radial distance R. The outer edge of the zone 72 is spaced radially inward from the outer edge of the PCA 311 by the prescribed radial distance R.

When an optical disc 30 having conditions similar to those in FIG. 27 is placed into the optical-disc drive apparatus 20 or when a prescribed instruction is issued to the optical-disc drive apparatus 20 from the host apparatus 10, the optical-disc drive apparatus 20 reads out the newest RMD from the RMA 312 or 322 for each of the first and second recording layers 301 and 302. The optical-disc drive apparatus 20 (the system controller 21) decides whether or not each of the PCAs 311 and 321 has been substantially fully used for the OPC procedure on the basis of the read-out RMD. When it is decided that the PCA 321 has been substantially fully used, the optical-disc drive apparatus 20 subjects the PCAs 311 and 321 to the DC erasure. Specifically, the optical-disc drive apparatus 20 erases all the recorded test signals from the used zones 70 and 72 (see FIG. 27). When it is decided that the PCA 311 has been substantially fully used, the optical-disc drive apparatus 20 similarly subjects the PCAs 311 and 321 to the DC erasure.

In some cases, the LPP address information can not be correctly read out from a section of the PCA 311 in the first recording layer 301 which has been used for the trial write and read, and thus which has been loaded with the test signals. When a test signal is recorded by use of the laser beam having a recording power exceeding an optimum level, recording marks wider than the groove track width are sometimes formed. Such excessively big recording marks make it difficult to correctly read out the LPP address information recorded thereabout. The optical-disc drive apparatus 20 reads out the LPP address information from the first recording layer 301 while the laser beam scans the first recording layer 301 in the direction from the inner disc edge toward the outer disc edge. As previously mentioned, the sections of the PCA 311 are sequentially used for the trial write and read in the order accorded with the radial direction from the outer disc edge toward the inner disc edge. Therefore, the laser beam does not meet excessively big recording marks and hence the LPP address information continues to be correctly read out from the first recording layer 301 until the laser beam reaches a section of the PCA 311 which should be used next for the trial write and read.

During a certain time interval before a stage for generating reproduced RF signals by scanning the last used section of the PCA 311, the laser beam does not meet excessively big recording marks and hence the LPP address information continues to be correctly read out from the first recording layer 301 until the laser beam reaches the last used section of the PCA 311.

With reference to FIGS. 26 and 27, the laser beam continues to meet the dummy-data-recorded zone 67 or 71 until reaching a section of the PCA 311 which should be used next for the trial write and read. In some cases, the recorded dummy data makes it difficult to correctly read out the LPP address information from the zone 67 or 71. While the laser beam scans the zone 67 or 71, the optical-disc drive apparatus 20 (the optical pickup 23) reads out the sector-number-added dummy data therefrom. The optical-disc drive apparatus 20 extracts every sector number from the read-out dummy data. The optical-disc drive apparatus 20 decides whether or not the LPP address information is correctly read out from the zone 67 or 71. In the event that the LPP address information is not correctly read out from the zone 67 or 71, the optical-disc drive apparatus 20 utilizes the extracted sector numbers instead of the LPP address information for the timing control of the trial write and read.

The optical-disc drive apparatus 20 reads out the LPP address information from the second recording layer 302 while the laser beam scans the second recording layer 302 in the direction from the outer disc edge toward the inner disc edge. As previously mentioned, the sections of the PCA 321 are sequentially used for the trial write and read in the order accorded with the radial direction from the inner disc edge toward the outer disc edge. Therefore, the laser beam does not meet excessively big recording marks and hence the LPP address information continues to be correctly read out from the second recording layer 302 until the laser beam reaches a section of the PCA 321 which should be used next for the trial write and read.

During a certain time interval before a stage for generating reproduced RF signals by scanning the last used section of the PCA 321, the laser beam does not meet excessively big recording marks and hence the LPP address information continues to be correctly read out from the second recording layer 302 until the laser beam reaches the last used section of the PCA 321.

As previously mentioned, the optical-disc drive apparatus 20 sequentially uses the sections of the PCA 311 in the first recording layer 301 for the trial write and read in the order accorded with the radial direction from the outer disc edge toward the inner disc edge. The optical-disc drive apparatus 20 sequentially uses the sections of the PCA 321 in the second recording layer 302 for the trial write and read in the order accorded with the radial direction from the inner disc edge toward the outer disc edge. During the trial write and read utilizing the PCA 321 in the second recording layer 302, the laser beam focused on the second recording layer 302 passes through the used zone in the first recording layer 301 which has been loaded with the sector-number-added dummy data or the test signals.

Almost the whole of the PCA 311 in the first recording layer 301 can be used for the trial write and read. Similarly, almost the whole of the PCA 321 in the second recording layer 302 can be used for the trial write and read. Thus, it is possible to increase the maximum number of times the reliable and accurate trial write and read (the reliable and accurate OPC procedure) can be performed by utilizing the PCA 311 or 321 until the PCA 311 or 321 deteriorates into an unacceptable range. This results in an increased maximum number of times of signal rewriting with respect to the optical disc 30.

As previously mentioned, the LPP address information continues to be correctly read out from the first recording layer 301 or the second recording layer 302 until the laser beam reaches a section of the PCA 311 or 321 which should be used next for the trial write and read. The correct read-out of the LPP address information allows the next trial write and read to be performed by utilizing an accurately-positioned section of the PCA 311 or 321.

During the trial write and read utilizing the PCA 321 in the second recording layer 302, the laser beam substantially always passes through the used zone in the first recording layer 301 and then reaches the PCA 321 in the second recording layer 302. Therefore, it is possible to stably decide an optimum recording power of the laser beam for the second recording layer 302. The recording of a signal on the data area in the second recording layer 302 can be performed by using the laser beam having the decided optimum recording power.

It should be noted that the first used section in the PCA 311 of the first recording layer 301 may be spaced radially from the outer edge of the PCA 311. Similarly, the first used section in the PCA 321 of the second recording layer 302 may be spaced radially from the inner edge of the PCA 321.

The dummy data may be recorded on the whole of the PCA 311 in the first recording layer 301 except the used zone loaded with the test signals.

The optical-disc drive apparatus 20 may subject only selected one or ones among the OPC used sections in the PCAs 311 and 321 to the DC erasure. In this case, one or more OPC used sections in the PCAs 311 and 321 remain in the used state. Preferably, an OPC used section or sections in the PCA 311 which remain in the used state are located in an outer region in the PCA 311. Preferably, an OPC used section or sections in the PCA 321 which remain in the used state are located in an inner region in the PCA 321.

In the case where the whole of the PCA 311 or 321 has been used for the trial write and read, only the PCA 311 or 321 may be subjected to the DC erasure.

The optical-disc drive apparatus 20 (the system controller 21) may read out the newest RMD from the RMA 312 or 322 for each of the first and second recording layers 301 and 302 while being released from a writing instruction and a reading instruction issued by the host apparatus 10.

### Fourth Embodiment

A fourth embodiment of this invention is similar to one of the first to third embodiments thereof except for design changes described hereafter.

Each of the PCAs 311 and 321 in the first and second recording layers 301 and 302 deteriorates as it repetitively undergoes a cycle of the trial write and read and the DC erasure. It is known that the degree of the deterioration of each of the PCAs 311 and 321 increases as the recording power of the laser beam during the trial write and read rises.

The optical-disc drive apparatus 20 sequentially uses the sections of the PCA 311 in the first recording layer 301 for the trial write and read in the order accorded with the radial direction from the outer disc edge toward the inner disc edge. The optical-disc drive apparatus 20 sequentially uses the sections of the PCA 321 in the second recording layer 302 for the trial write and read in the order accorded with the radial direction from the inner disc edge toward the outer disc edge.

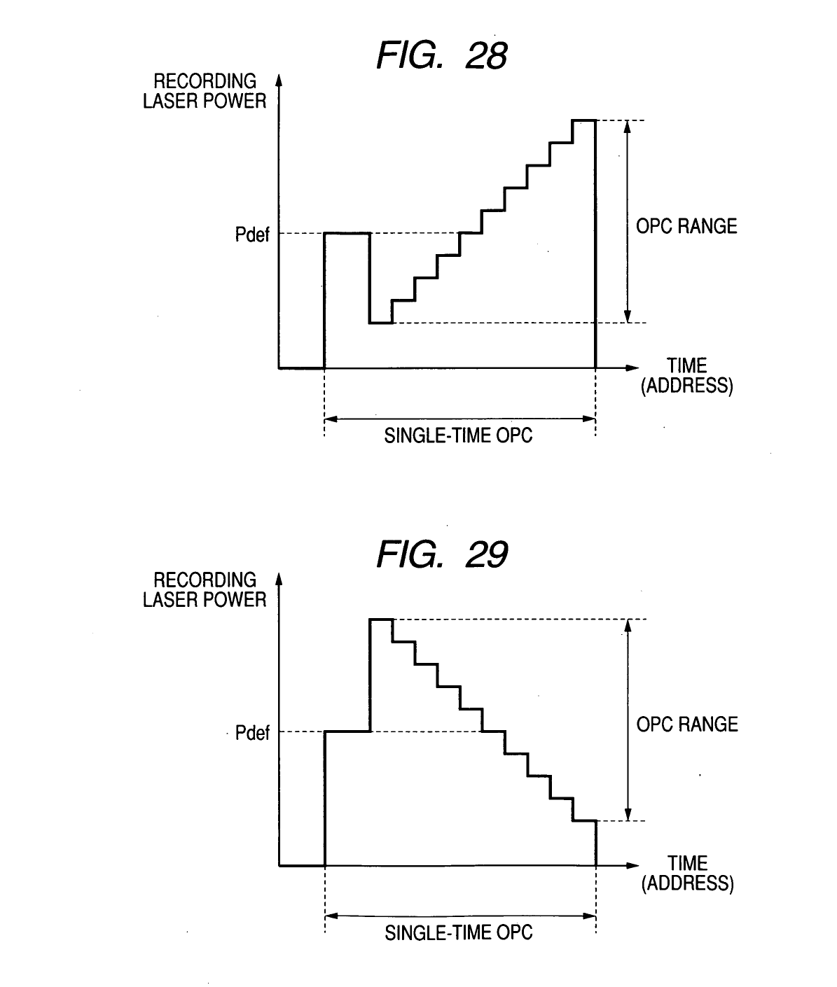

With reference to FIG. 28, during an initial stage of every single-time OPC procedure (every single-time trial write and read) until the first exhaustion of all the sections in the PCAs 311 and 321, the optical-disc drive apparatus 20 records a test signal on the present PCA section while maintaining the recording power of the laser beam at the center value Pdef. During a later stage of every single-time OPC procedure, the optical-disc drive apparatus 20 sequentially records test signals on the present PCA section while changing the recording power of the laser beam among ten different values on an upward stepwise basis.

After all the sections in the PCAs 311 and 321 have been used, the optical-disc drive apparatus 20 subjects the PCAs 311 and 321 to the DC erasure. Thereafter, the optical-disc drive apparatus 20 sequentially reuses the sections of the PCA 311 for the trial write and read in the order accorded with the radial direction from the outer disc edge toward the inner disc edge. The optical-disc drive apparatus 20 sequentially reuses the sections of the PCA 321 for the trial write and read in the order accorded with the radial direction from the inner disc edge toward the outer disc edge. In this case, during an initial stage of every single-time OPC procedure (every single-time trial write and read), the optical-disc drive apparatus 20 records a test signal on the present PCA section while maintaining the recording power of the laser beam at the center value Pdef as shown in FIG. 29. During a later stage of every single-time OPC procedure, the optical-disc drive apparatus 20 sequentially records test signals on the present PCA section while changing the recording power of the laser beam among ten different values on a downward stepwise basis as shown in FIG. 29.

In both the cases of FIGS. 28 and 29, during an initial stage of every single-time OPC procedure, the optical-disc drive apparatus 20 records a test signal on the present PCA section while maintaining the recording power of the laser beam at the center value Pdef. The center value Pdef is a reference for the OPC range covering the different power values. For example, the ten different power values extend from −30% to +40% decrements or increments with respect to the center value Pdef (that is, from 70% to 140% of the center value Pdef). The center value Pdef is expected to be equal or close to an optimum recording power.

During every single-time OPC procedure using the PCA 311 in the first recording layer 301, the present PCA section is scanned by the laser beam in a direction from the inner disc edge toward the outer disc edge. As previously mentioned, during an initial stage of every single-time OPC procedure, the optical-disc drive apparatus 20 records a test signal on the present PCA section while maintaining the recording power of the laser beam at the center value Pdef. Therefore, during a later stage of every single-time OPC procedure, the optical-disc drive apparatus 20 can surely reproduce an RF signal, which originates from the recorded test signal corresponding to the center power value Pdef, from an innermost part of the present PCA section. The sure reproduction of the RF signal enables the optical-disc drive apparatus 20 to reliably find the boundary of the last used PCA section and stably implement the OPC procedure.

During every single-time OPC procedure using the PCA 321 in the second recording layer 302, the present PCA section is scanned by the laser beam in a direction from the outer disc edge toward the inner disc edge. As previously mentioned, during an initial stage of every single-time OPC procedure, the optical-disc drive apparatus 20 records a test signal on the present PCA section while maintaining the recording power of the laser beam at the center value Pdef. Therefore, during a later stage of every single-time OPC procedure, the optical-disc drive apparatus 20 can surely reproduce an RF signal, which originates from the recorded test signal corresponding to the center power value Pdef, from an outermost part of present PCA section. The sure reproduction of the RF signal enables the optical-disc drive apparatus 20 to reliably find the boundary of the last used PCA section and stably implement the OPC procedure.

To allow a decision as to which of the power changing patterns in FIGS. 28 and 29 should be used for the forthcoming trial write, the optical-disc drive apparatus 20 provides the RMD with a field called a recording power direction flag. The optical-disc drive apparatus 20 initially sets the recording power direction flag to “0”. As previously mentioned, the optical-disc drive apparatus 20 reads out the newest RMD from the optical disc 30. The optical-disc drive apparatus 20 (the system controller 21) checks whether the recording power direction flag in the read-out RMD is “0” or “1”. When the recording power direction flag is “0”, the optical-disc drive apparatus 20 uses the power changing pattern in FIG. 28 for the forthcoming trial write and read.

Each time all the sections of the PCAs 311 and 321 are used and then the PCAs 311 and 321 are subjected to the DC erasure, the optical-disc drive apparatus 20 generates RMD in which the recording power direction flag is inverted with respect to the last one. Subsequently, the optical-disc drive apparatus 20 records the generated RMD on the optical disc 30. For example, the new recording power direction flag is “1” when the last one is “0”. As previously mentioned, the optical-disc drive apparatus 20 reads out the newest RMD from the optical disc 30. The optical-disc drive apparatus 20 (the system controller 21) checks whether the recording power direction flag in the read-out RMD is “0” or“1”. When the recording power direction flag is “1”, the optical-disc drive apparatus 20 uses the power changing pattern in FIG. 29 for the forthcoming trial write and read.

Each of the sections of the PCAs 311 and 321 alternately undergoes the trial write and read using the upward stepwise power changing pattern of FIG. 28 and the trial write and read using the downward stepwise power changing pattern of FIG. 29. Therefore, a specified part of each PCA section is prevented from more frequently receiving a high recording laser power so that the whole of the PCA section deteriorates more slowly. Accordingly, it is possible to provide an increased maximum number of times of signal rewriting with respect to the optical disc 30.

It should be noted that for every single-time trial write and read, the optical-disc drive apparatus 20 may select one from the power changing patterns in FIGS. 28 and 29 at random and use the selected pattern. In this case, the number of times each PCA section is used for the trial write and read with the power changing pattern in FIG. 28 is substantially equal to the number of times the PCA section is used for the trial write and read with the power changing pattern in FIG. 29. Therefore, a specified part of each PCA section is prevented from more frequently receiving a high recording laser power so that the whole of the PCA section deteriorates more slowly. Accordingly, it is possible to provide an increased maximum number of times of signal rewriting with respect to the optical disc 30.

During every single-time OPC procedure (every single-time trial write and read) for which the recording power of the laser beam is changed among the ten different values, the optical-disc drive apparatus 20 may change the erasing power of the laser beam while maintaining the recording power of the laser beam at each of the ten different values. Alternatively, during every single-time OPC procedure for which the recording power of the laser beam is changed among the ten different values, the optical-disc drive apparatus 20 may change the erasing power of the laser beam while maintaining the recording power of the laser beam at former one of the ten different values or each of former ones of the ten different values. In these cases, the optical-disc drive apparatus 20 decides an optimum erasing power of the laser beam in addition to an optimum recording power thereof as a result of the OPC procedure. Then, the optical-disc drive apparatus 20 calculates the ratio between the decided optimum erasing power and the decided optimum recording power.

It should be noted that the optical disc 30 may be of a single-layer type rather than the two-layer single-sided type.

### Fifth Embodiment

A fifth embodiment of this invention is similar to the first to fourth embodiments thereof except that the optical disc 3 includes a laminate of three or more recording layers.

### Sixth Embodiment

A sixth embodiment of this invention is similar to the first to fifth embodiments thereof except for design changes described hereafter.

According to the sixth embodiment of this invention, the control program for the optical-disc drive apparatus 20 is initially stored in a recording medium. The recording medium is connected with the optical-disc drive apparatus 20 and is driven therein so that the control program is loaded from the recording medium into the program memory 24.

Alternatively, the control program may be downloaded to the program memory 24 via a transmission line or a communication line.

What is claimed is:

1. An apparatus for recording information on a rewritable optical disc having a laminate of recording layers including first and second recording layers each with a trial write area, the apparatus comprising:
first means for sequentially using sections of the trial write area in the first recording layer in an order accorded with a radial direction from an outer disc edge toward an inner disc edge while recording test signals thereon;
second means for sequentially using sections of the trial write area in the second recording layer in an order accorded with a radial direction from the inner disc edge toward the outer disc edge while recording test signals thereon;
third means for calculating a radial distance between an innermost one of used ones among the sections of the trial write area in the first recording layer and an outermost one of used ones among the sections of the trial write area in the second recording layer;
fourth means for deciding whether or not the radial distance calculated by the third means is greater than a preset threshold value; and
fifth means for erasing the recorded test signals from the used ones among the sections of the trial areas in the first and second recording layers when the fourth means decides that the radial distance is not greater than the preset threshold value.

2. An apparatus for recording information on a rewritable optical disc having a laminate of recording layers including first and second recording layers each with a trial write area, the apparatus comprising:
first means for sequentially using sections of the trial write area in the first recording layer in an order accorded with a radial direction from an outer disc edge toward an inner disc edge while recording test signals thereon;
second means for sequentially using sections of the trial write area in the second recording layer in an order accorded with a radial direction from the inner disc edge toward the outer disc edge while recording test signals thereon;
third means for calculating a radial distance between an innermost one of used ones among the sections of the trial write area in the first recording layer and an outermost one of used ones among the sections of the trial write area in the second recording layer;
fourth means for deciding whether or not the radial distance calculated by the third means is greater than a preset threshold value;
fifth means for calculating a size of a used zone defined by the used ones among the sections of the trial write area in the first recording layer;
sixth means for calculating a size of a used zone defined by the used ones among the sections of the trial write area in the second recording layer;
seventh means for deciding which of the sizes calculated by the fifth and sixth means is greater;
eighth means for erasing the recorded test signals from the used ones among the sections of the trial area in the first recording layer when the fourth means decides that the radial distance is not greater than the preset threshold value and the seventh means decides that the size calculated by the fifth means is greater; and
ninth means for erasing the recorded test signals from the used ones among the sections of the trial area in the second recording layer when the fourth means decides that the radial distance is not greater than the preset threshold value and the seventh means decides that the size calculated by the sixth means is greater.

3. An apparatus as recited in claim 1, wherein the preset threshold value is chosen in the light of (1) a manufacturing tolerance for the optical disc and (2) a diameter of a laser beam in one of the first and second recording layers which is focused through the one of the first and second recording layers on the other of the first and second recording layers.

4. An apparatus as recited in claim 2, wherein the preset threshold value is chosen in the light of (1) a manufacturing tolerance for the optical disc and (2) a diameter of a laser beam in one of the first and second recording layers which is focused through the one of the first and second recording layers on the other of the first and second recording layers.

5. An apparatus for recording information on a rewritable optical disc having a laminate of recording layers including first and second recording layers each with a trial write area, the apparatus comprising:
first means for using a first zone in the trial write area of the first recording layer for trial write;
second means for recording dummy data on a second zone in the trial write area of the first recording layer, the second zone being separate from the first zone; and
third means for using the trial write area of the second recording layer for trial write while applying a laser beam to the trial write area of the second recording layer through either the first zone in the trial write area of the first recording layer which has been used by the first means or the second zone in the trial write area of the first recording layer on which the dummy data has been recorded by the second means.

6. An apparatus as recited in claim 5, wherein the dummy data has portions related with on-disc address information.

7. An apparatus as recited in claim 5, further comprising fourth means for subjecting a part of the second zone to DC erasure and then using the part for trial write before adding the part to the first zone to expand the first zone.

8. An apparatus as recited in claim 5, wherein the first means includes means for using the first zone in the trial write area of the first recording layer for trial write and read to decide an optimum recording power of the laser beam, and the second means includes means for recording the dummy data on the second zone in the trial write area of the first recording layer while applying the laser beam having the decided optimum recording power thereto.

9. An apparatus for recording information on a rewritable optical disc having a trial write area, the apparatus comprising:
first means for selecting one from a first power changing pattern in which a recording power of a laser beam is initially equal to a value expected to correspond to an optimum recording power and is then changed from a minimum value to a maximum value on an upward stepwise basis and a second power changing pattern in which the recording power of the laser beam is initially equal to the value expected to correspond to the optimum recording power and is then changed from the maximum value to the minimum value on a downward stepwise basis; and
second means for using the trial write area while applying thereto a laser beam having a recording power which varies in accordance with the power changing pattern selected by the first means.

10. An apparatus as recited in claim 9, wherein the first means comprises means for alternately selecting the first power changing pattern and the second power changing pattern.

11. An apparatus as recited in claim 9, wherein the first means comprises means for selecting one from the first power changing pattern and the second power changing pattern at random.

12. A method of recording information on a rewritable optical disc having a laminate of recording layers including first and second recording layers each with a trial write area, the method comprising the steps of:
sequentially using sections of the trial write area in the first recording layer in an order accorded with a radial direction from an outer disc edge toward an inner disc edge while recording test signals thereon;
sequentially using sections of the trial write area in the second recording layer in an order accorded with a radial direction from the inner disc edge toward the outer disc edge while recording test signals thereon;
calculating a radial distance between an innermost one of used ones among the sections of the trial write area in the first recording layer and an outermost one of used ones among the sections of the trial write area in the second recording layer;
deciding whether or not the calculated radial distance is greater than a preset threshold value; and
erasing the recorded test signals from the used ones among the sections of the trial areas in the first and second recording layers when it is decided that the calculated radial distance is not greater than the preset threshold value.

13. A method of recording information on a rewritable optical disc having a laminate of recording layers including first and second recording layers each with a trial write area, the method comprising the steps of:
sequentially using sections of the trial write area in the first recording layer in an order accorded with a radial direction from an outer disc edge toward an inner disc edge while recording test signals thereon;
sequentially using sections of the trial write area in the second recording layer in an order accorded with a radial direction from the inner disc edge toward the outer disc edge while recording test signals thereon;
calculating a radial distance between an innermost one of used ones among the sections of the trial write area in the first recording layer and an outermost one of used ones among the sections of the trial write area in the second recording layer;
deciding whether or not the calculated radial distance is greater than a preset threshold value;
calculating a first size of a used zone defined by the used ones among the sections of the trial write area in the first recording layer;
calculating a second size of a used zone defined by the used ones among the sections of the trial write area in the second recording layer;
deciding which of the calculated first and second sizes is greater;
erasing the recorded test signals from the used ones among the sections of the trial area in the first recording layer when it is decided that the calculated radial distance is not greater than the preset threshold value and that the calculated first size is greater; and
erasing the recorded test signals from the used ones among the sections of the trial area in the second recording layer when it is decided that the calculated radial distance is not greater than the preset threshold value and that the calculated second size is greater.
